(19) United States
(12) Patent Application Publication
(10) Pub. No.: US 2026/0012649 A1
(43) Pub. Date: Jan. 8, 2026

(54) BITDEPTH RANGE INFORMATION SUPPLEMENTAL ENHANCEMENT INFORMATION

(71) Applicant: Nokia Technologies Oy, Espoo (FI)

(72) Inventors: Jill BOYCE, Portland, OR (US); Miska Matias HANNUKSELA, Tampere (FI)

(21) Appl. No.: 19/260,714

(22) Filed: Jul. 7, 2025

Related U.S. Application Data
(60) Provisional application No. 63/667,958, filed on Jul. 5, 2024.

(51) Int. Cl. H04N 19/70; H04N 19/167; H04N 19/172

(52) U.S. Cl. CPC H04N 19/70; H04N 19/167; H04N 19/172

(57) ABSTRACT

An apparatus including: at least one processor; and at least one memory storing instructions that, when executed by the at least one processor, cause the apparatus at least to: allocate a first set of at least one bit of original content of a source picture to a first range of at least one bit; allocate a second set of at least one bit of the original content of the source picture to a second range of at least one bit; form a formed picture comprising a first region based on the first range of at least one bit and a second region based on the second range of at least one bit; code the formed picture into a coded picture.

### TECHNICAL FIELD

The examples and non-limiting embodiments relate generally to bitdepth range information for supplemental enhancement information (SEI).

### SUMMARY

An apparatus including: at least one processor; and at least one memory storing instructions that, when executed by the at least one processor, cause the apparatus at least to: allocate a first set of at least one bit of original content of a source picture to a first range of at least one bit; allocate a second set of at least one bit of the original content of the source picture to a second range of at least one bit; form a formed picture comprising a first region based on the first range of at least one bit and a second region based on the second range of at least one bit; code the formed picture into a coded picture.

An apparatus including: at least one processor; and at least one memory storing instructions that, when executed by the at least one processor, cause the apparatus at least to: receive a coded picture; wherein the coded picture comprises an allocation of a first set of at least one bit of original content of a source picture to a first range of at least one bit that is coded into a first region; wherein the coded picture comprises an allocation of a second set of at least one bit of the original content of the source picture to a second range of at least one bit that is coded into a second region; and reconstruct a target picture having a bit depth comprising a bit depth of the coded picture, based on: the allocation of the first set of at least one bit of original content of the source picture to the first range of at least one bit that is coded into the first region, and the allocation of the second set of at least one bit of the original content of the source picture to the second range of at least one bit that is coded into the second region.

An apparatus including: at least one processor; and at least one memory storing instructions that, when executed by the at least one processor, cause the apparatus at least to: allocate a first set of at least one bit of original content of a source picture to a first range of at least one bit; allocate a second set of at least one bit of the original content of the source picture to a second range of at least one bit; form a first formed picture based on the first range of at least one bit; form a second formed picture based on the second range of at least one bit; code, using the first formed picture, the first range of at least one bit into a first coded picture, wherein the first coded picture comprises a number of at least one bit; code, using the second formed picture, the second range of at least one bit into a second coded picture, wherein the second coded picture comprises a number of at least one bit; and signal information related to at least one of: the coding of the first range of at least one bit into the first coded picture, or the coding of the second range of at least one bit into the second coded picture; wherein the signaled information comprises at least one of: a position of a first bit of the original content for the first range and a number of at least one bit allocated to the first range, or a position of a first bit of the original content for the second range and a number of at least one bit allocated to the second range. In one variant of example 32, the number of at least one bit of the first coded picture is the same as the number of at least one bit of the second coded picture. In another variant of example 32, the number of at least one bit of the first coded picture is different from the number of at least one bit of the second coded picture.

An apparatus including: at least one processor; and at least one memory storing instructions that, when executed by the at least one processor, cause the apparatus at least to: receive a first coded picture and a second coded picture; wherein the first coded picture comprises an allocation of a first set of at least one bit of original content of a source picture to a first range of at least one bit that is coded into the first coded picture; wherein the second coded picture comprises an allocation of a second set of at least one bit of the original content of the source picture to a second range of at least one bit that is coded into the second coded picture; receive signaled information related to at least one of: a coding of the first range of at least one bit into the first coded picture, or a coding of the second range of at least one bit into the second coded picture; wherein the signaled information comprises at least one of: a position of a first bit of the original content of the source picture for the first range and a number of at least one bit allocated to the first range, or a position of a first bit of the original content of the source picture for the second range and a number of at least one bit allocated to the second range; and reconstruct at least one target picture having a bit depth comprising a bit depth of at least one of the first coded picture or the second coded picture, based on the signaled information.

An apparatus including: at least one processor; and at least one memory storing instructions that, when executed by the at least one processor, cause the apparatus at least to: allocate a set of at least one bit of original content of a source picture to a range of at least one bit; form a formed picture comprising a region based on the range of at least one bit; code the formed picture into a coded picture; and signal information comprising an offset that applies to the coded picture, wherein the offset indicates a number of zero or more positions a bit in samples corresponding to the range is shifted to a higher order position.

An apparatus including: at least one processor; and at least one memory storing instructions that, when executed by the at least one processor, cause the apparatus at least to: receive a coded picture; wherein the coded picture comprises an allocation of a set of at least one bit of original content of a source picture to a range of at least one bit that is coded into a region; receive signaled information comprising an offset that applies to the coded picture, wherein the offset indicates a number of zero or more positions a bit in samples corresponding to the range is shifted to a higher order position; and reconstruct a target picture having a bit depth comprising a bit depth of the coded picture, based on the signaled information.

A method including: allocating a first set of at least one bit of original content of a source picture to a first range of at least one bit; allocating a second set of at least one bit of the original content of the source picture to a second range of at least one bit; forming a formed picture comprising a first region based on the first range of at least one bit and a second region based on the second range of at least one bit; coding the formed picture into a coded picture.

A method including: receiving a coded picture; wherein the coded picture comprises an allocation of a first set of at least one bit of original content of a source picture to a first range of at least one bit that is coded into a first region; wherein the coded picture comprises an allocation of a second set of at least one bit of the original content of the source picture to a second range of at least one bit that is coded into a second region; and reconstructing a target picture having a bit depth comprising a bit depth of the coded picture, based on: the allocation of the first set of at least one bit of original content of the source picture to the first range of at least one bit that is coded into the first region, and the allocation of the second set of at least one bit of the original content of the source picture to the second range of at least one bit that is coded into the second region.

A method including: allocating a first set of at least one bit of original content of a source picture to a first range of at least one bit; allocating a second set of at least one bit of the original content of the source picture to a second range of at least one bit; forming a first formed picture based on the first range of at least one bit; forming a second formed picture based on the second range of at least one bit; coding, using the first formed picture, the first range of at least one bit into a first coded picture, wherein the first coded picture comprises a number of at least one bit; coding, using the second formed picture, the second range of at least one bit into a second coded picture, wherein the second coded picture comprises a number of at least one bit; and signaling information related to at least one of: the coding of the first range of at least one bit into the first coded picture, or the coding of the second range of at least one bit into the second coded picture; wherein the signaled information comprises at least one of: a position of a first bit of the original content for the first range and a number of at least one bit allocated to the first range, or a position of a first bit of the original content for the second range and a number of at least one bit allocated to the second range. In one variant of example 42, the number of at least one bit of the first coded picture is the same as the number of at least one bit of the second coded picture. In another variant of example 42, the number of at least one bit of the first coded picture is different from the number of at least one bit of the second coded picture.

A method including: receiving a first coded picture and a second coded picture; wherein the first coded picture comprises an allocation of a first set of at least one bit of original content of a source picture to a first range of at least one bit that is coded into the first coded picture; wherein the second coded picture comprises an allocation of a second set of at least one bit of the original content of the source picture to a second range of at least one bit that is coded into the second coded picture; receiving signaled information related to at least one of: a coding of the first range of at least one bit into the first coded picture, or a coding of the second range of at least one bit into the second coded picture; wherein the signaled information comprises at least one of: a position of a first bit of the original content of the source picture for the first range and a number of at least one bit allocated to the first range, or a position of a first bit of the original content of the source picture for the second range and a number of at least one bit allocated to the second range; and reconstructing at least one target picture having a bit depth comprising a bit depth of at least one of the first coded picture or the second coded picture, based on the signaled information.

A method including: allocating a set of at least one bit of original content of a source picture to a range of at least one bit; forming a formed picture comprising a region based on the range of at least one bit; coding the formed picture into a coded picture; and signaling information comprising an offset that applies to the coded picture, wherein the offset indicates a number of zero or more positions a bit in samples corresponding to the range is shifted to a higher order position.

A method including: receiving a coded picture; wherein the coded picture comprises an allocation of a set of at least one bit of original content of a source picture to a range of at least one bit that is coded into a region; receiving signaled information comprising an offset that applies to the coded picture, wherein the offset indicates a number of zero or more positions a bit in samples corresponding to the range is shifted to a higher order position; and reconstructing a target picture having a bit depth comprising a bit depth of the coded picture, based on the signaled information.

### BACKGROUND

It is known to perform data compression and data decompression in a multimedia system.

### BRIEF DESCRIPTION OF THE DRAWINGS

The foregoing embodiments and other features are explained in the following description, taken in connection with the accompanying drawings, wherein:

FIG. 1 shows an example depth map with a 16-bit source.

FIG. 2 shows a range 0 (MSBs) on the left, and a range 1 (LSBs) on the right.

FIG. 3A shows an example allocation of bits to ranges.

FIG. 3B shows coded bit positions in range 0.

FIG. 3C shows coded bit positions in range 1.

FIG. 4A shows an example allocation of bits to a range.

FIG. 4B shows coded bit positions in range 0.

FIG. 5 is a block diagram of a coding and decoding process (or codec), based on the examples described herein.

FIG. 6 shows an example implementation of a clipping function Clip3.

FIG. 7 shows an encoder according to an embodiment.

FIG. 8 shows a decoder according to an embodiment.

FIG. 9 is a block diagram illustrating a system in accordance with an example.

FIG. 10 is an example apparatus configured to implement the examples described herein.

FIG. 11 shows a representation of an example of non-volatile memory media used to store instructions that implement the examples described herein.

FIG. 12 is an example method, based on the examples described herein.

FIG. 13 is an example method, based on the examples described herein.

FIG. 14 is an example method, based on the examples described herein.

FIG. 15 is an example method, based on the examples described herein.

FIG. 16 is an example method, based on the examples described herein.

FIG. 17 is an example method, based on the examples described herein.

### DETAILED DESCRIPTION OF EXAMPLE EMBODIMENTS

An elementary unit for the input to an encoder and an output of a decoder, respectively, may be a picture. A picture given as an input to an encoder may also be referred to as a source picture, and a picture decoded by a decoder may be referred to as a decoded picture or a reconstructed picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

Typically, video is encoded in YUV or YCbCr color space as that is found to reflect some characteristics of human visual system and allows using lower quality representation for Cb and Cr channels as human perception is less sensitive to the chrominance fidelity those channels represent.

Video may be represented using different bit depths. Use of a higher bit depth allows for more precision and/or a larger dynamic range that use of a lower bit depth. For example, high Dynamic Range (HDR) content is frequently coded using 10 or more bits of bit depth rather than 8 bits.

Version 1 of the High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (VVC) (MPEG-I Part 3), a.k.a. ITU-T H.266, is a video compression standard developed by the Joint Video Experts Team (JVET) of the Moving Picture Experts Group (MPEG), (formally ISO/IEC JTC1 SC29 WG11) and Video Coding Experts Group (VCEG) of the International Telecommunication Union (ITU) to be the successor to HEVC/H.265.

A specification of the AV1 bitstream format and decoding process were developed by the Alliance for Open Media (AOM). The AV1 specification was published in 2018. AOM is reportedly working on the AV2 specification.

Some key definitions, bitstream and coding structures, and concepts of some video coding standards and specifications are described in this section for providing background for a video encoder, decoder, encoding method, decoding method, and a bitstream structure, wherein the embodiments may be implemented. It is to be understood that embodiments are not limited to the referenced video coding standards or specifications.

A bitstream may be defined as a sequence of bits or a sequence of syntax structures. A bitstream format may constrain the order of syntax structures in the bitstream.

A syntax element may be defined as an element of data represented in a bitstream. A syntax structure may be defined as zero or more syntax elements present together in a bitstream in a specified order.

Syntax structures may be specified, for example, using arithmetic, logical, relational, bit-wise, and assignment operators similar to those available in many programming languages. For example, & may indicate a bit-wise ‘AND’ operation. Furthermore, syntax structures may be specified with reference to mathematical functions.

Syntax structures and semantics may use the values of variables derived from the values of syntax elements. Naming conventions may be defined for variables. For example, variables may be named by a mixture of lower case and upper case letter and without any underscore characters. Variables starting with an upper case letter may be derived for the decoding of the current syntax structure and all depending syntax structures. Variables starting with an upper case letter may, in some cases, be used in the decoding process for later syntax structures without mentioning the originating syntax structure of the variable. Variables starting with a lower case letter may only be used in relation to the syntax structure or function they have been defined for.

An elementary unit for the output of an encoder and the input of a decoder, respectively, may be a Network Abstraction Layer (NAL) unit. For transport over packet-oriented networks or storage into structured files, NAL units may be encapsulated into packets or similar structures. A bytestream format has been specified in some video coding standards for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

A bitstream may be defined to logically include a syntax structure, such as a NAL unit, when the syntax structure is transmitted along the bitstream but may be included in the bitstream according to the bitstream format. A bitstream may be defined to natively comprise a syntax structure, when the bitstream includes the syntax structure.

In some coding formats or standards, a bitstream may be in the form of a network abstraction layer (NAL) unit stream or a byte stream, that forms the representation of coded pictures and associated data forming one or more coded video sequences.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

In some coding standards, NAL units include a header and payload. In some coding standards, the NAL unit header indicates the type of the NAL unit. In some coding standards, the NAL unit header indicates a scalability layer identifier (e.g., called nuh_layer_id), which may be used, e.g., for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

Bitstreams or coded video sequences may be encoded to be temporally scalable as follows. Each picture may be assigned to a particular temporal sub-layer. A temporal sub-layer may be equivalently called a sub-layer, temporal sublayer, sublayer, or temporal level. Temporal sub-layers may be enumerated, e.g., from 0 upwards. The lowest temporal sub-layer, sub-layer 0, may be decoded independently. Pictures at temporal sub-layer 1 may be predicted from reconstructed pictures at temporal sub-layers 0 and 1. Pictures at temporal sub-layer 2 may be predicted from reconstructed pictures at temporal sub-layers 0, 1, and 2, and so on. In other words, a picture at temporal sub-layer N does not use any picture at temporal sub-layer greater than N as a reference for inter prediction. The bitstream created by excluding all pictures greater than or equal to a selected sub-layer value and including pictures remains conforming.

Each picture of a temporally scalable bitstream may be assigned with a temporal identifier (also known as TID, temporal layer identifier, sub-layer identifier, sublayer identifier, temporal sub-layer identifier, temporal sublayer identifier, or temporal layer ID), which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming. Consequently, a picture having TemporalId equal to tid_value does not use any picture having a TemporalId greater than tid_value as a prediction reference. In some video coding standards, a sub-layer or a temporal sub-layer may be defined to be a temporal scalable layer (or a temporal layer, TL) of a temporal scalable bitstream, consisting of VCL NAL units with a particular value of the TemporalId variable and the associated non-VCL NAL units.

NAL units can be categorized into Video Coding Layer (VCL) NAL units and non-VCL NAL units. VCL NAL units are typically coded slice NAL units.

A non-VCL NAL unit may be for example one of the following types: a video parameter set (VPS), a sequence parameter set (SPS), a picture parameter set (PPS), a supplemental enhancement information (SEI) NAL unit, an access unit delimiter, an end of sequence (EOS) NAL unit, an end of bitstream (EOB) NAL unit, or a filler data NAL unit. Parameter sets may be needed for the reconstruction of decoded pictures, whereas many of the other non-VCL NAL units may not be necessary for the reconstruction of decoded sample values.

A coded picture may be defined as a coded representation of a picture.

In some coding formats, picture unit (PU) may be defined as a set of data units, such as NAL units, that are associated with each other, are consecutive in decoding order, and contain exactly one coded picture. For example, certain non-video-coding data units, such as non-VCL NAL units, may be next to coded video data units in decoding order and the respective picture unit may comprise both these non-video-coding data units and the video coding data units of a coded picture.

In some coding formats, an access unit (AU) may be defined as a set of NAL units that are associated with each other according to a specified classification rule, are consecutive in decoding order, and include at most one coded picture at any scalability layer (e.g., with any specific value of nuh_layer_id in some coding formats, such as HEVC or VVC). In some coding formats, an access unit comprises one or more complete picture units. In some coding formats, in addition to including the VCL NAL units of a coded picture, an access unit may also include non-VCL NAL units associated with the coded picture. Said specified classification rule may, for example, associate pictures with the same output time or picture order count value into the same access unit.

In some coding formats, a coded video sequence (CVS) may be defined as a sequence of coded pictures in decoding order that is independently decodable and is followed by another coded video sequence or the end of the bitstream.

In some coding formats, such as AV1, a coded video sequence comprises one or more temporal units. A temporal unit consists of a series of OBUs starting from a temporal delimiter, optional sequence headers, optional metadata OBUs, a sequence of one or more frame headers, each followed by zero or more tile group OBUs as well as optional padding OBUs. A temporal unit may be defined to comprise all the OBUs that are associated with a specific, distinct time instant. A temporal unit may comprise a temporal delimiter OBU, and all the OBUs that follow, up to but not including the next temporal delimiter. A temporal delimiter OBU may be defined as an indication that the following OBUs will have a different presentation/decoding time stamp from the one of the last frame prior to the temporal delimiter.

A coded layer video sequence (CLVS) may be defined as a sequence of pictures and associated other data within the same scalable layer (e.g., with the same value of nuh_layer_id) that is decodable independently of other pictures in the same layer.

The HEVC and VVC standards define profiles which limit the bit depth used to code video content. VVC profiles are defined for 10, 12, and 16 bit limits. HEVC profiles are defined for 8, 10, 12, 14, and 16 bit limits. HEVC Main 10 profile, which limits to 10 bits, is the most widely deployed profile of HEVC, and the profile used in all known hardware implementations of HEVC encoder and decoders. Use of hardware encoders and decoders is beneficial for many applications, because of low cost and high throughput.

The HEVC and VVC standards enable lossless coding through a feature called trans quant bypass, in which the usual block transform and quantization steps are not applied to the prediction residual, which is directly coded.

Video coding specifications may enable the use of supplemental enhancement information (SEI) messages or alike. SEI messages may not be required for the decoding of output pictures but may assist in related processes, such as picture output timing, post-processing of decoded pictures, rendering, error detection, error concealment, and resource reservation. Several SEI messages are specified, e.g. in H.265/HEVC, H.266/VVC, and H.274/VSEI standards, and the user data SEI messages enable organizations and companies to specify SEI messages for their own use.

Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages,

Some video coding specifications enable metadata OBUs. A metadata OBU comprises a type field, which specifies the type of metadata. A metadata OBU may be understood to be similar to an SEI NAL unit or an SEI message.

ITU-T Recommendation H.274, which is equivalent to ISO/IEC 23002-7, may be called “versatile supplemental enhancement information messages for coded video bitstreams” and be referred to as “versatile supplemental enhancement information” or VSEI. The VSEI standard specifies the syntax and semantics of video usability information (VUI) parameters and supplemental enhancement information (SEI) messages. The VUI parameters and SEI messages defined in the VSEI standard are designed to be conveyed within coded video bitstreams in a manner specified in a video coding specification or to be conveyed by other means determined by the specifications for systems that make use of such coded video bitstreams. The VSEI standard is intended for use with VVC coded video bitstreams, although it is drafted in a manner intended to be sufficiently generic that it may also be used with other types of coded video bitstreams.

Multiple video coding standards enable coding of depth content, which represents the distance of an object from the camera. Depth content is typically represented in an inverse distance format, using Znear and Zfar parameters as described in the depth representation info SEI message in VVC or HEVC.

In some video coding formats, such as VVC, a subpicture may be defined as a rectangular region of one or more slices within a picture, wherein the one or more slices are complete. An independent VVC subpicture is treated like a picture in the VVC decoding process. When the motion compensation would reference a sample location outside of boundaries of an independent VVC subpicture, the sample location is saturated to be within the subpicture. Moreover, it may additionally be required that loop filtering across the boundaries of an independent VVC subpicture is disabled. Boundaries of a subpicture are treated like picture boundaries in the VVC decoding process when sps_subpic_treated_as_pic_flag[i] is equal to 1 for the subpicture. Loop filtering across the boundaries of a subpicture is disabled in the VVC decoding process when sps_loop_filter_across_subpic_enabled_pic_flag[i] is equal to 0.

A constituent rectangles SEI message may be implemented. Constituent rectangles (CRs) are rectangular regions within a coded picture, for which their size and position is signaled. A constituent rectangle type may signaled, such as texture, alpha, or depth. A constituent rectangle type identifier may be signaled, or its value may be inferred the index order.

The constituent rectangles SEI messages may use subpicture parameters to identify the size and position of CRs to save bitrate, but use of subpictures is not required. Subpictures have normative encoder/decoder behaviors, while the constituent rectangles SEI, like other SEI messages, doesn't have any normative impact, but can be used for post-processing.

A constituent rectangle nesting SEI message may be used to indicate the constituent rectangle(s) and contain one or more SEI messages, which may be referred to as CR-nested SEI messages. The semantics of the CR-nested SEI messages apply to the constituent rectangle(s) indicated in the constituent rectangle nesting SEI message.

Scalable video coding may refer to coding structure where one bitstream may include multiple representations of the content, for example, at different bitrates, resolutions or frame rates. In these cases the receiver can extract the desired representation depending on its characteristics (e.g., resolution that matches best the display device). Alternatively, a server or a network element may extract the portions of the bitstream to be transmitted to the receiver depending on, e.g., the network characteristics or processing capabilities of the receiver. A meaningful decoded representation may be produced by decoding only certain parts of a scalable bitstream. A scalable bitstream typically include of a ‘base layer’ providing the lowest quality video available and one or more enhancement layers that enhance the video quality when received and decoded together with the lower layers. In order to improve coding efficiency for the enhancement layers, the coded representation of that layer typically depends on the lower layers. For example, the motion and mode information of the enhancement layer can be predicted from lower layers. Similarly, the pixel data of the lower layers can be used to create prediction for the enhancement layer.

It needs to be understood that the description of scalable video coding may be generalized to any scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer.

A multi-layer bitstream is a bitstream comprising multiple layers, which may be, but are not limited to, base and enhancement layers as discussed above for scalable video coding. A multi-layer bitstream may additionally or alternatively comprise independent layers that do not have inter-layer prediction relationship between each other and may even represent different types of content. Any multi-layer bitstream may be regarded as a scalable video bitstream.

A scalable nesting SEI message contains one or more SEI messages. The SEI messages contained in the scalable nesting SEI message are also referred to as the scalable-nested SEI messages. A scalable nesting SEI message comprises information indicative of which subset of the bitstream the scalable-nested SEI messages apply. For example, VVC includes a scalable nesting (SN) SEI message, which provides information to associate scalable-nested SEI messages with specific output layer sets (OLSs), specific layers, or specific sets of subpictures.

Bit-wise operations may be defined as follows:
& bit-wise “and”
   When operating on integer arguments, operates on a two's complement representation of the integer value. When operating on a binary argument that contains fewer bits than another argument, the shorter argument is extended by adding more significant bits equal to 0.
   | bit-wise “or”
   When operating on integer arguments, operates on a two's complement representation of the integer value. When operating on a binary argument that contains fewer bits than another argument, the shorter argument is extended by adding more significant bits equal to 0.
\hat{ } bit-wise “exclusive or”
   When operating on integer arguments, operates on a two's complement representation of the integer value. When operating on a binary argument that contains fewer bits than another argument, the shorter argument is extended by adding more significant bits equal to 0.
x>>y arithmetic right shift of a two's complement integer representation of x by y binary digits
   This function is defined only for non-negative integer values of y. Bits shifted into the most significant bits (MSBs) as a result of the right shift have a value equal to the MSB of x prior to the shift operation.
x<<y arithmetic left shift of a two's complement integer representation of x by y binary digits
   This function is defined only for non-negative integer values of y. Bits shifted into the least significant bits (LSBs) as a result of the left shift have a value equal to 0.

The “<<” operation may interchangeably be referred to as left shifting or bit-shifting to the left. The “>>” operation may interchangeably be referred to as right shifting or bit-shifting to the right.

Reducing the distortion in image and video compression is often intended to increase human perceptual quality, as humans are considered to be the end users, i.e. consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. Example use cases and applications are self-driving cars, video surveillance cameras and public safety, smart sensor networks, smart TV and smart advertisement, person re-identification, smart traffic monitoring, drones, etc.

It is likely that the receiver-side device has multiple “machines” or neural networks (NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

Video coding for machines (VCM) may be generally defined as video coding for which the intended usage of the decoded video includes one or more machine analysis or computer vision tasks. VCM may be realized with a conventional codec, such as HEVC or VVC, or a dedicated VCM codec that may provide suboptimal video output for human viewing.

A bit truncation method has been suggested for VCM. Bit truncation includes right shifting input content before encoding to reduce bitrate, and optionally left shifting after decoding. Most significant bits (MSBs) and least significant bits (LSBs) may be separated into separate pictures.

A method to encode high bit-depth video by lower bit-depth encoders and a continuity transform may be implemented. In this case, the high bit-depth source is divided into an MSB part and an LSB part. The MSB part is losslessly coded as a primary picture, and the LSB part is transformed by a continuity mapping and then encoded as an auxiliary picture. An SEI message may be used to combine the MSB and the LSB parts. 16-bit video may be separated into two 8-bit depth sources which are coded separately for lossless operation. When MSBs and LSBs are coded separately, compression errors in the MSB have much greater influence on the quality of the reconstructed sample formed by combining the MSB and LSB.

For video content representing outdoor scenes with depth maps, variation in distances can be very large. For example, a scene could contain a person who is close to the camera and a distant mountain in the background. When larger ranges of distances are represented in the same scene, for a given bit depth, the precision of the represented depth is poorer than when the distance variation is smaller. To properly signal depth maps with distances representing both close and distant objects, using only 10 bits is insufficient, and can lead to objectionable visual artifacts when using depth for reprojection.

While 16-bit video codec profiles can be used to retain more accuracy, encoder and decoder products supporting 16 bits are much less widely available than products supporting 8- and 10-bit profiles. It is desirable to code high bit depth content using lower bit depth video encoders and decoders.

Described herein is a method to allocate bits of an original source video into one or more bit depth ranges, with each range coded separately. Prior solutions are limited to two ranges, containing MSBs or LSBs.

The terms bit-depth range, bit range, and range may be used interchangeably in embodiments.

The examples described herein enable the ability to code multiple ranges within the same coded picture, by using subpictures or constituent rectangles to represent a range. Prior solutions required that each range be coded in a separate picture, in some cases an auxiliary picture. The methods described herein allow ranges to be coded in single layer pictures or multiple layer pictures in an access unit.

The examples described herein include signaling for each range a bit offset to indicate the position of the significant bits of a range in the coded sample. When multiple ranges are included within the same coded picture, this allows the ranges representing more significant bits to be less impacted by compression errors by placing them in high order bit positions, when a quantization parameter is applied to the entire picture. The examples described herein allow the use of lossy coding and does not require lossless coding.

The examples described herein include a process to reconstruct a target picture of the same bit-depth as the encoder source picture. Rounding offsets and clipping operations are used in the defined process, according to the signaled parameters, in order to be robust to compression errors. Prior solutions do not define the use of rounding offsets.

An SEI message is proposed to enable allocating bits of high-bit depth video content into bit ranges, with each range coded as a separate layer picture, subpicture, or constituent rectangle using an 8-bit or 10-bit profile of a video codec, such as HEVC Main, HEVC Main 10, or VVC Main 10 profile. The semantics define a process for reconstructing a target picture with the same bit-depth as the original picture.

For each bit range, syntax elements signal the position of the first bit of the original content for that range, the number of bits allocated to that range, and the position of the first bit in the coded picture/subpicture/constituent rectangle.

If coded pictures are used, each range is coded in a different layer, e.g. with a different value of nuh_layer_id. If subpictures or constituent rectangles are used, multiple ranges can be coded in different regions of single layer pictures.

The examples described herein can be used with lossy coding and does not require use of lossless coding. Lossy coding leading to compression errors in the most significant bits from the original picture is a much more significant problem compression errors in the least significant bits. To reduce the likelihood and mount of compression errors for the most significant bits (MSBs), they can be placed in a higher bit position in the coded picture by left shifting the allocated bits.

With the proposed SEI message, an encoder has flexibility to select the number of bits and bit positions in the coded picture(s) and can select those parameters to reduce the amount and likelihood of loss in the higher order bit range(s) relative to the low order bit range(s). Placing the MSBs in a higher bit position in the coded picture reduces the amount of compression error in the significant bits. The encoder can also choose to reduce the quantization parameter (QP) to reduce compression error.

Encoder implementations treat content differently depending on which bit positions are occupied with significant data. Additionally, some encoder implementations do not enable assigning different QP values to different regions of the same picture, so when multiple ranges are included within separate regions within the same picture, it is useful to have a different effective QP value for the different ranges.

Depth content is typically flatter and can be coded much more efficiently than texture video, so very small QP values may be used without requiring a high bitrate. If a use case requires guarantees that there will be no coding errors in the MSBs, the encoder can use trans quant bypass for the picture/subpicture/constituent rectangle containing the MSBs.

The herein described SEI message can also support bit-depth truncation in which bits are discarded from the original video, either using a single range or using multiple ranges.

Embodiments are presented below in relation to a bitdepth range information SEI message.

The SEI message syntax describes the contents of one or more bit-depth ranges, by signaling one or more syntax element(s) indicative of the following for each range: Number of bits allocated to the range, and Offset position for the significant bits in the coded picture.

In an embodiment, the bit depth of the original source content is also signaled in the SEI message.

In an embodiment, an encoder can consider the use case and target bitrate of the application when choosing how many ranges to use, how many bits to allocate to each range, and the bit positions in which to place the allocated bits.

In an embodiment, syntax of the SEI message also identifies the location of where the ranges are coded in the picture(s) of the access unit. Each range may be coded as a complete picture, or may be coded in a region of a picture, using subpicture or constituent rectangles to identify the region. A flag is used to indicate that picture partitioning is used, and if that flag is set, a subpicture identifier or constituent rectangle identifier is signalled per range.

In an embodiment, a flag is used to indicate whether multiple layers are used to code the ranges. If the flag is set, a scalability layer identifier value, such as a nuh_layer_id value, is signalled per range. If the flag is not set, the SEI message applies to the current layer.

In an embodiment, semantics indicate the encoder pre-processing process and describe a decoder post-processing process to reconstruct a target picture of the same bit-depth as the encoder source picture. Rounding offsets and clipping operations are used in the defined processes, in order to be robust to compression errors, especially for ranges containing MSBs, as they have significantly more impact on the reconstructed sample value than the LSB ranges.

In an embodiment, at the encoder, for ranges other than the range containing the least significant bits an encoder rounding offset is added, calculated from the signaled parameters for original bit depth and the number of bits in the range. This allows small compression errors in the coded picture corresponding to the MSB range(s) to not impact the reconstructed value, unless the compression error is large. The rounding offset is inversed at the decoder when forming the reconstructed picture samples.

In an embodiment, an additional decoding rounding offset, based on the bit offset, is added at the decoder, based on the bit offset.

A clipping operation is calculated based upon the maximum allowable value of a range, given the number of bits and the bit offset. In the absence of clipping, compression errors may result in overflow, in which the decoded value exceeds the maximum allowable value, or underflow, in which because of the subtraction of the rounding offset the decoded value could effectively be negative.

The proposed SEI message can be used by HEVC or VVC, or by other video coding standards. Proposed standards text is provided for use of the proposed SEI message by VVC.

An example embodiment of the syntax of the bitdepth range information SEI message is presented below.

| | Descriptor |
|---|---|
| bitdepth_range_info( payloadSize ) { | |
| bri_orig_bit_depth_minus1 | u(4) |
| bri_num_ranges_minus1 | u(2) |
| if ( bri_num_ranges_minus1 > 0 ) { | |
| bri_nuh_layer_id_present_flag | u(1) |
| bri_pic_partition_flag | u(1) |
| if( bri_pic_partition_flag ) { | |
| bri_partition_type_flag | u(1) |
| bri_partition_id_len_minus1 | u(4) |
| } | |
| } | |
| for( i = 0; i <= bri_num_ranges_minus1; i++ ) { | |
| if ( bri_nuh_layer_id_present_flag ) | |
| bri_nuh_layer_id[ i ] | u(6) |
| if ( bri_pic_partition_flag ) | |
| bri_partition_id[ i ] | u(v) |
| bri_num_bits_in_range_minus1[ i ] | u(4) |
| bri_bit_offset[ i ] | u(v) |
| } | |
| } | |

An example embodiment of the semantics of the bitdepth range information SEI message is presented below.

The Bitdepth range information (BRI) SEI message enables reconstruction of a target picture of the same bit depth as an original source picture by inverting operations performed by the encoder to allocate bit ranges of the original source picture to one or more ranges coded in separate layer pictures, subpictures, or constituent rectangles.

Use of this SEI message requires the definition of the following variables, where i is the layer identifier of a layer that may be present in the current CVS:
A chroma format indicator, denoted herein by ChromaFormatIdc[i], as described in clause Error! Reference source not found.
A bit depth for the samples, denoted herein by BitDepth[i].
An array of picture width and picture height in units of luma samples, denoted herein by PicWidthInLumaSamples[i] and PicHeightInLumaSamples[i], respectively.
An array of subpicture counts, denoted by NumSubpics[i].
Arrays of the width and height of the subpictures, denoted herein by SubPicWidth[i][j] and SubPicHeight[i][j] respectively, where j is the subpicture index in 0 . . . NumSubpics[i]−1.

bri_orig_bit_depth_minus1 plus 1 specifies the bit depth of the original picture.

The variable origBitDepth is set equal to bri_orig_bit_depth_minus1+1.

bri_num_ranges_minus1+1 specifies the number of ranges used for allocating bits of the original picture.

The variable briNumRanges is set equal to bri_num_ranges_minus1+1.

bri_nuh_layer_id_present_flag equal to 1 specifies that the bri_nuh_layer_id[i] syntax element is present in the SEI message. bri_nuh_layer_id_present_flag equal to 0 specifies that the bri_nuh_layer_id[i] syntax element is not present in the SEI message.

bri_pic_partition_flag equal to 1 specifies that the bri_partition_id[i] syntax element is present. bri_pic_partition_flag equal to 0 specifies that the bri_partition_id[i] syntax element is not present.

bri_partition_type_flag equal to 1 specifies that each range is coded as a constituent rectangle. bri_partition_type_flag equal to 0 specifies that each range is coded as a subpicture.

When bri_partition_type_flag equal to 1, it is a requirement of bitstream conformance that there is a constituent rectangles SEI message preceding the BRI SEI message in decoding order in the current PU.

bri_partition_id_len_minus1+1 specifies the length of the bri_rect_id[i] and bri_subpic_id[i] syntax elements.

bri_nuh_layer_id[i], when present, specifies the layer identifier of the texture component of the i-th display overlay. When not present, the value of bri_nuh_layer_id[i] is inferred to be equal to the layer identifier of the PU containing the BRI SEI message.

If this SEI message is present in any layer in the current AU, it is a requirement of bitstream conformance that a BRI SEI message with the same payload is present in the layer with layer identifier bri_nuh_layer_id[0].

bri_partition_id[i], when present and bri_partition_type_flag equal to 1, specifies the cr_rect_id[j] of the texture component of the i-th display overlay. bri_partition_id[i], when present and bri_partition_type_flag equal to 0, specifies the subpicture index of the texture component of the i-th display overlay. When not present, the value of bri_partition_id[i] is inferred to be equal to 0.

When bri_partition_type_flag equal to 1, bri_partition_id[i] shall be in the range of 0 . . . cr_num_rects_minus1[bri_nuh_layer_id[i]]−1. When bri_partition_type_flag equal to 0, bri_partition_id[i] shall be in the range of 0 to NumSubpics [bri_nuh_layer_id[i]]−1, inclusive.

bri_num_bits_in_range_minus1[i]+1 specifies the number of bits in the i-th range. bri_num_bits_in_range_minus1[i] shall be in the range of 0 to BitDepth[i]−1, inclusive.

The variable numBits[i] is set equal to bri_num_bits_in_range_minus1[i]+1.

bri_bit_offset[i] specifies a bit shifting parameter used to derive the target picture. The length of the syntax element is Ceil (Log2 (BitDepth[i])). bri_bit_offset[i] shall be in the range of 0 to BitDepth[i]−numBits[i].

If bri_pic_partition_flag is equal to 0, the following applies:
CodedWidth[i] is set equal to PicWidthInLumaSamples[bri_nuh_layer_id[i]]].
CodedHeight[i] is set equal to PicWidthInLumaSamples[bri_nuh_layer_id[i]].
CodedRange[i] is set equal to the cropped decoded picture from the layer with layer identifier bri_nuh_layer_id[i] in the AU

Otherwise, if bri_partition_type_flag is equal to 0, the following applies:
CodedWidth[i] is set equal to SubPicWidth[bri_nuh_layer_id[i]] [bri_partition_id[i]].
CodedHeight[i] is set equal to SubPicHeight[bri_nuh_layer_id[i]] [bri_partition_id[i]].
CodedRange[i] is set equal to the subpicture with subpicture index bri_partition_id[i] from the layer with layer identifier bri_nuh_layer_id[i].

Otherwise (bri_partition_type_flag is equal to 1), the following applies:
CodedWidth[i] is set equal to CrRectWidth[bri_nuh_layer_id[i]] [bri_rect_id[i]].
CodedHeight[i] is set equal to CrRectHeight[bri_nuh_layer_id[i]] [bri_rect_id[i]].
CodedRange[i] is set equal to the constituent rectangle with cr_rect_id[j] equal to bri_partition_id[i] from the layer with layer identifier bri_nuh_layer_id[i].

It is a requirement of bitstream conformance that CodedWidth[i] and CodedHeight[i], respectively, have equal values for all i in 0 . . . bri_num_ranges−1.

The samples SampleToCode[i] of CodedRange[i], for i in 0 . . . briNumRanges, are indicated to have been pre-processed prior to encoding from an original source picture of resolution CodedWidth[0]×CodedHeight[0] with chroma format ChromaFormatIdc and bit depth origBitDepth, according to the process of subclause 8.X.2.1.

Each sample, TargetSample, of a target picture of resolution CodedWidth[0]×CodedHeight[0] with chroma format ChromaFormatIdc, may be reconstructed using the Target sample reconstruction process described in subclause 8.X.2.2, for each sample, decodedSample[i] of CodedRange[i] for i in 0 . . . briNumRanges.

In an example embodiment, an encoding system pre-processes a sample of the video as follows:

SampleToCode[i] for i in 0 . . . briNumRanges is derived as follows:

```
currOrigBitPos = 0
currSample = inputSample
for (i = 0; i < briNumRanges; i++) {
  mask = ( 1 << numBits[ i ] ) − 1
  k = origBitDepth − currOrigBitPos − numBits[ i ]
  shiftedInput = inputSample >> k
  SampleToCode[ i ] = ( shiftedInput & mask ) << bri_bit_offset[ i ]
  currOrigBitPos += numBits[ i ]
}
```

In an example embodiment, a decoding system reconstructs a target sample as follows:

TargetSample is derived as follows:

```
  TargetSample = 0
  currTargetBitPos = 0
  TargetSample = 0
  for (i = 0; i < briNumRanges; i++) {
    k = origBitDepth − currTargetBitPos − numBits[ i ]
    maxVal = (1 << (numBits[ i ] + bri_bit_offset[ i ])) − 1
    if (bri_bit_offset[ i ] > 0)
      decRoundingOffset = 1 << ( bri_bit_offset[ i ] − 1 )
    else
      decRoundingOffset = 0
    adjustedDecodedSample = Clip3( 0, max Val, decodedSample[ i ] +
decRoundingOffset)
    shiftedDecodedSample = adjustedDecodedSample >> bri_bit_offset[ i ]
    TargetSample += shiftedDecodedSample << k
    currTargetBitPos += numBits[ i ]
  }
```

In an example embodiment, for purposes of interpretation of the bitdepth range information SEI message, the following variables are specified from syntax elements of a VVC bitstream and/or variables derived by the VVC decoding process:
ChromaFormatIdc[i] is set equal to sps_chroma_format_idc, of the picture with nuh_layer_id equal to i.
BitDepth[i] is set equal to BitDepth, of the picture with nuh_layer_id equal to i.
PicWidthInLumaSamples[i] and PicHeightInLumaSamples[i] are set equal to pps_pic_width_in_luma_samples and pps_pic_height_in_luma_samples, respectively, of the picture with nuh_layer_id equal to i.
NumSubpics[i] is set equal to sps_num_subpics_minus1+1 of the picture with nuh_layer_id equal to i.
SubPicWidth[i][j] is set equal to (sps_subpic_width_minus1[j]+1)*CtbSizeY−1 of the picture with nuh_layer_id equal to i.
SubPicHeight[i][j] is set equal to (sps_subpic_height_minus1[j]+1)*CtbSizeY−1 of the picture with nuh_layer_id equal to i.

### Variations

In the provided syntax and semantics, the parameters signaled per range for the number of bits and bit offset are applied to both luma and chroma components, when chroma components are present. In an embodiment, when coding content with 3 components, in addition to syntax elements for the luma component, additional syntax elements can be signaled for the chroma components together, or for each chroma component individually. Some of syntax elements may be the same syntax elements or a subset of the syntax elements that have been presented in other embodiments. Some of the syntax elements may be indicative of the same information for each or both chroma component as has been presented in other embodiments but may be expressed differently, for example with differential syntax elements in relation to the respective syntax elements for the luma component.

In the provided syntax and semantics, separate flags are used to indicate the presence of a layer identifier and a partition identifier, which enables unique identification of the location of a range coded within a particular region of a particular layer.

In another embodiment, a single flag can be used to indicate that either a layer identifier or a partition identifier is signaled per range, but not both. This places a restriction that each range can either be coded as a full picture in a separate layer or as a separate region within a single layer.

Alternative processes for use of rounding offsets and clipping may be defined, utilizing different signaled syntax elements, for the goal of avoiding errors in the reconstructed sample values, especially of the MSB range(s).

The proposed syntax enables the use of between one and four ranges. More ranges might be enabled. Or the syntax could be modified to support only two ranges, in which case it is unnecessary to signal the number of ranges, and the processes can be simplified to restrict to the use of two ranges.

### High Bit-Depth Content Example

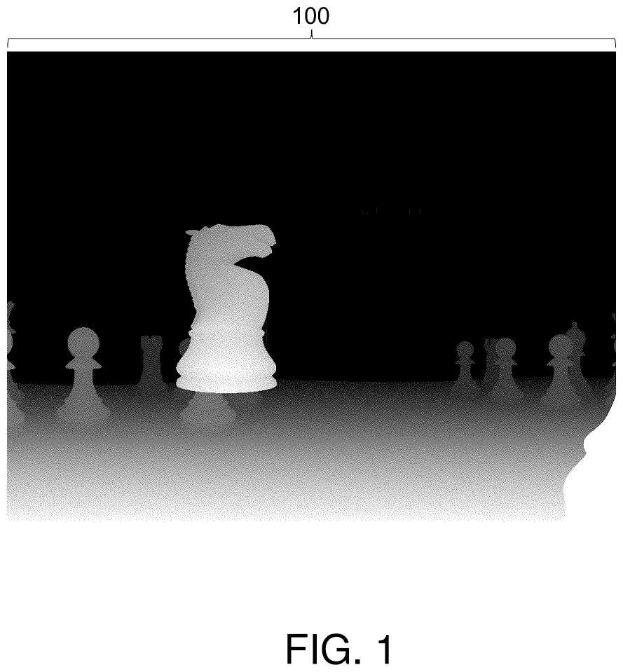

An example usage of the SEI message is provided for coding depth maps with 16-bit source using VVC Main profile with 10-bit bit depth. FIG. 1 shows an example depth map 100. In particular, FIG. 1 shows an example depth map 100 with 16-bit source.

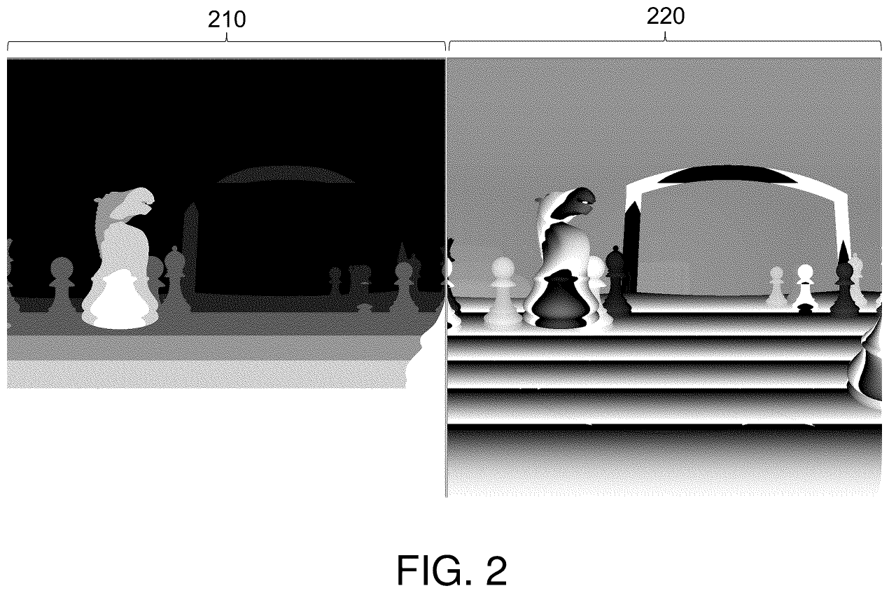

Using the herein described SEI message, two ranges are defined, with the 6 MSBs allocated to range 0, and the 10 LSBs allocated to range 1, as illustrated in FIG. 2. In particular, FIG. 2 shows Range 0 (MSBs) on the left (210), and Range 1 (LSBs) on the right (220).

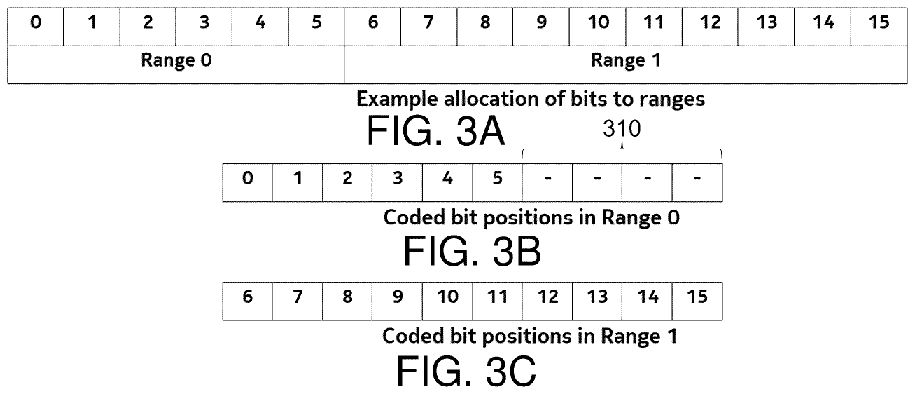

FIG. 3A shows the allocation of bits to ranges. 6 bits are allocated to Range 0, taken from the most significant bits of the original content, and the remaining 10 least significant bits are allocated to Range 1. Thus, FIG. 3A shows an example allocation of bits to ranges.

FIG. 3B shows how those 6 bits (namely 0, 1, 2, 3, 4, and 5) are placed at the highest order bit position in the 10-bit picture to be encoded, with zeros filled in the other bit positions (collectively 310), in order to maintain the highest accuracy after compression. Thus, FIG. 3B shows coded bit positions in Range 0.

FIG. 3C shows how the 10 least significant bits of the original content are allocated to Range 1. Thus, FIG. 3C shows coded bit positions in Range 1.

The two ranges can be coded as pictures in separate layers, or the two ranges may be composited within a single picture using subpictures or constituent rectangles.

An encoder may select a low QP when coding range 0 to reduce or avoid compression artifacts. An encoder may choose to use lossless coding to guarantee no compression artifacts, using the trans quant bypass feature.

Table 1 shows parameters for the example in section 1.1, in which 16-bit content is split into two ranges. Range 0 contains the 6 MSBs, which are placed in the high order bit position, e.g. shifted left by 4 bits. Range 1 contains the 10 LSBs, which are not shifted.

TABLE 1
Range Parameters for 16-bit content example

| Range | | |
|---|---|---|
| i | numBits[ i ] | bri_bit_offset[ i ] |
| 0 | 6 | 4 |
| 1 | 10 | 0 |

### Bit-Truncation Example

An example usage of the SEI message is provided for bit truncation of 10-bit input content coding to 4 bits.

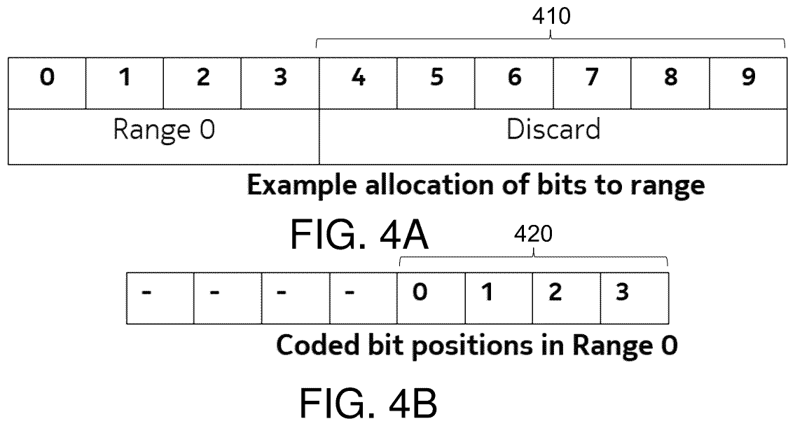

FIG. 4A shows the allocation of bits to ranges. 4 bits are allocated to Range 0, taken from the high order bits of the original content. Thus, FIG. 4A shows an example allocation of bits to a range.

FIG. 4B shows how those 4 bits are placed at the lowest order bit position (collectively 420) in the 10-bit picture to be encoded. The lowest order 6 bits of the original content (collectively 410) are discarded. Thus, FIG. 4B shows coded bit positions in Range 0.

Table 2 shows parameters for the bit truncation example in section 1.2, where 4 bits of 10 bit content is included in range 0, and the remaining 6 bits are discarded.

TABLE 2
Range Parameters for Bit-truncation example

| Range | | |
|---|---|---|
| i | numBits[ i ] | bri_bit_offset[ i ] |
| 0 | 4 | 0 |

### Alternative Embodiment Using Nesting SEI Message(s)

In an alternative embodiment, either or both of layer identifier and partition identifier indications are included in one or more nesting SEI messages that include the BRI SEI message.

For example, one or both of the following nesting SEI messages may be used, but embodiments are not limited to them:
The scalable nesting SEI message specified in VVC may be used to indicate the scalability layer(s) and/or the subpicture(s) that the nested BRI SEI message concerns.
The constituent rectangle nesting SEI message may be used to indicate the constituent rectangle(s) that the nested BRI SEI message concerns.

It may be specified that when the BRI SEI message is not nested in a scalable nesting SEI message, it applies to the value of nuh_layer_id of the SEI NAL unit that includes the BRI SEI message.

Multiple nested BRI SEI messages may be present, each concerning different scalability layer(s), subpicture(s), and/or constituent rectangle(s).

A set of BRI SEI messages that describes the original video may be identified by including an identifier (below called bri_orig_id without loss of generality) in the BRI SEI message.

One BRI SEI message may provide the value of one bit range, as indicated by bri_num_bits_in_range_minus1[brid_idx] and bri_bit_offset[bri_idx] without loss of generality. The index bri_idx indicates the order of bit ranges in the set of BRI SEI messages that describe the same original video. It may be required that the values of bri_idx for the same original video shall be contiguous and start from 0. The greatest value of bri_idx for the same original video corresponds to bri_num_ranges_minus1 in the syntax presented earlier.

An example syntax is presented below:

| | Descriptor |
|---|---|
| bitdepth_range_info( payloadSize ) { | |
| bri_orig_id | ue(v) |
| bri_orig_bit_depth_minus1 | u(4) |
| bri_idx | u(2) |
| bri_num_bits_in_range_minus1[ bri_idx ] | u(4) |
| bri_bit_offset[ bri_idx ] | u(v) |
| } | |

The value of bri_orig_bit_depth_minus1 may be required to be the same in all BRI SEI messages with the same value of bri_orig_id.

### Alternative Embodiment for Fine-Grained Value Range Scaling

It may be considered that bit-shifting to the right is effectively the same as an integer division with truncation of the result toward zero where the divisor is a power of two. Likewise, it may be considered that bit-shifting to the left is effectively the same as multiplication with a power of two.

In an embodiment, any other embodiment is modified so that bit-shifting to the right is effectively replaced by a division, and bit-shifting to the left is effectively replaced by a multiplication. Consequently, a fine-grained value range scaling can be achieved.

In an embodiment, any other embodiment is modified so that bit-shifting to the right is effectively replaced by a combination of a multiplication followed by bit-shifting to the right, and bit-shifting to the left is effectively replaced by a multiplication. Consequently, a fine-grained value range scaling can be achieved and a division operation is avoided, which may be more costly in terms of computations than the combination of multiplication followed by bit-shifting to the right.

In an embodiment, fine-grained value range scaling may be limited to the case where only one bit range is in use. The limitation may be enforced in semantics and/or through gating of a new syntax elements in the embodiments of this subsection.

In an embodiment, one or more syntax elements are collectively indicative of a multiplication scaling factor are indicated in the BRI SEI message.

In an embodiment, a syntax element indicative of a number of bits (e.g. bri_num_bits_in_range_minus1[i] and a syntax element indicative of a maximum value (e.g. called bri_mult_scale_max_minus1[i] below) are collectively indicative of a multiplication scaling factor.

For example, the following syntax element may be added to any syntax embodiment above:

| | |
|---|---|
| bri_mult_scale_max_minus1[ i ] | u(v) |

bri_mult_scale_max_minus1[i] is used to derive a multiplication scaling factor. The values of bri_mult_scale_max_minus1[i] for i in 0 . . . briNumRanges may be used to convert one or more decoded sample values to a sample value in the original bit depth. The length of bri_mult_scale_max_minus1[i] is equal to briNumBits[i] in bits. When not present, bri_mult_scale_max_minus1[i] is inferred to be (1<<briNumBits[i])−1. A multiplication scaling factor, briMultScale[i], is set equal to (bri_mult_scale_max_minus1[i]+1)=(1<<briNumBits[i]). The operator÷may be defined as a division where no truncation or rounding is intended. Any equation where the operator÷may return a Real value.

In an example, a maximum value subsequent to multiplicative scaling (below called briScMaxVal[i] without loss of generality) is derived to be equal to (1<<numBits[i])−1. In another example, briScMaxVal[i] is set to Round (((1<<numBits[i])−1)*briMultScale[i]). The function Round may be defined to return the closest integer value.

In an example embodiment, an encoding system pre-processes a sample of the video as follows:

```
SampleToCode[ i ] for i in 0 .. briNumRanges is derived as follows:
  currOrigBitPos = 0
  for (i = 0; i < briNumRanges; i++) {
    k = origBitDepth − currOrigBitPos − numBits[ i ]
    shiftedInput = Round( ( inputSample >> k ) * briMultScale[ i ] )
    SampleToCode[ i ] = Clip3( 0, briScMaxVal[ i ], shiftedInput ) << bri_bit_offset[ i ]
    currOrigBitPos += numBits[ i ]
  }
```

In an example embodiment, a decoding system reconstructs a target sample as follows:

```
TargetSample is derived as follows:
  TargetSample = 0
  currTargetBitPos = 0
  TargetSample = 0
  for (i = 0; i < briNumRanges; i++) {
    k = origBitDepth − currTargetBitPos − numBits[ i ]
    maxVal = (1 << (numBits[ i ] + bri_bit_offset[ i ])) − 1
    if (bri_bit_offset[ i ] > 0)
      decRoundingOffset = 1<< ( bri_bit_offset[ i ] − 1 )
    else
      decRoundingOffset = 0
    adjustedDecodedSample = Clip3( 0, maxVal, decodedSample[ i ] +
decRoundingOffset)
    shiftedDecodedSample = Clip3( 0, briScMaxVal[ i ], adjustedDecodedSample >>
bri_bit_offset[ i ] )
    TargetSample += ( Round( shiftedDecodedSample ÷ briMultScale[ i ] ) ) << k
    currTargetBitPos += numBits[ i ]
  }
```

It is to be understood that embodiments may be realized with a different set of rounding and clipping operations. For example, in a variation the operation “Clip3 (0, max Val, decodedSample[i]+decRoundingOffset)” may be replaced by “decodedSample [i]+decRoundingOffset”.

An example usage of this embodiment is provided for compacting 8-bit input content coding with a multiplication scaling factor in the range of 0.5 to 1, exclusive. Consequently, the value of bri_mult_scale_max_minus1[i] is in the range of 128 to 254, inclusive, which corresponds to briMultScale[i] the range of 129÷256 to 255÷256, inclusive. This is effectively equivalent to bit truncation by less than 1 bit.

Embodiments have been described in relation to the bitdepth range information SEI message. It is to be understood that embodiments may be similarly realized through any other SEI message.

The encoder optimization information (EOI) SEI message has been included in a draft of VSEI version 4. The EOI SEI message is used to indicate if the video has been optimized for human viewing or machine analysis and which types of optimization have been applied in pre-processing or encoding. The EOI SEI message includes the eoi_type syntax element, which indicates the types of optimization method as a bit mask.

In an embodiment, syntax elements presented in the embodiments are added in the encoder optimization information (EOI) SEI message.

In an example embodiment, a bit mask position for the eoi_type in the encoder optimization information SEI message is defined to indicate if bitdepth range optimization has been applied. For example, without loss of generality, the 0x40 may be used for indicating the bitdepth range optimization and may, for example, be defined as follows: the pictures for which this SEI message persists have been pre-processed so that the sample value range of one or more of the colour components have been modified. If eoi_type indicates that bitdepth range optimization has been applied, the variable EoiBitdepthRangeFlag may be set equal to 1, and otherwise EoiBitdepthRangeFlag may be set equal to 0.

In an example, the following syntax of the EOI SEI message with bitdepth range information may be used. It needs to be understood that any other syntax with similar bitdepth range information may likewise be used.

| | Descriptor |
|---|---|
| encoder_optimization_info(payloadSize ) { | |
| eoi_cancel_flag | u(1) |
| if( !eoi_cancel_flag ) { | |
| eoi_persistence_flag | u(1) |
| eoi_for_human_viewing_idc | u(2) |
| eoi_for_machine_analysis_idc | u(2) |
| eoi_type | u(16) |
| if( EoiObjectBasedFlag ) | |
| eoi_object_based_idc | ue(v) |
| if( EoiTemporalResamplingFlag ) { | |
| eoi_temporal_resampling_type_flag | u(1) |
| eoi_num_int_pics | ue(v) |
| } | |
| if(EoiSpatialResamplingFlag) | |
| eoi_spatial_resampling_type_flag | u(1) |
| if( EoiPrivacyProtectionFlag ) { | |
| eoi_privacy_protection_type_idc | u(4) |
| eoi_privacy_protected_info_type | u(8) |
| } | |
| if( EoiBitdepthRangeFlag ) { | |
| eoi_bri_orig_id | ue(v) |
| eoi_bri_orig_bit_depth_minus1 | u(4) |
| eoi_bri_idx | u(2) |
| eoi_bri_num_bits_in_range_minus1[ bri_idx ] | u(4) |
| eoi_bri_bit_offset[ bri_idx ] | u(v) |
| } | |
| } | |
| } | |

The semantics of the syntax elements prefixed by eoi_bri_may be specified similar to the respective syntax elements with prefix bri_in an earlier embodiment.

In an example embodiment, when bitdepth range information is indicated in the EOI SEI message, the alternative embodiment using nesting SEI message(s) may be additionally applied.

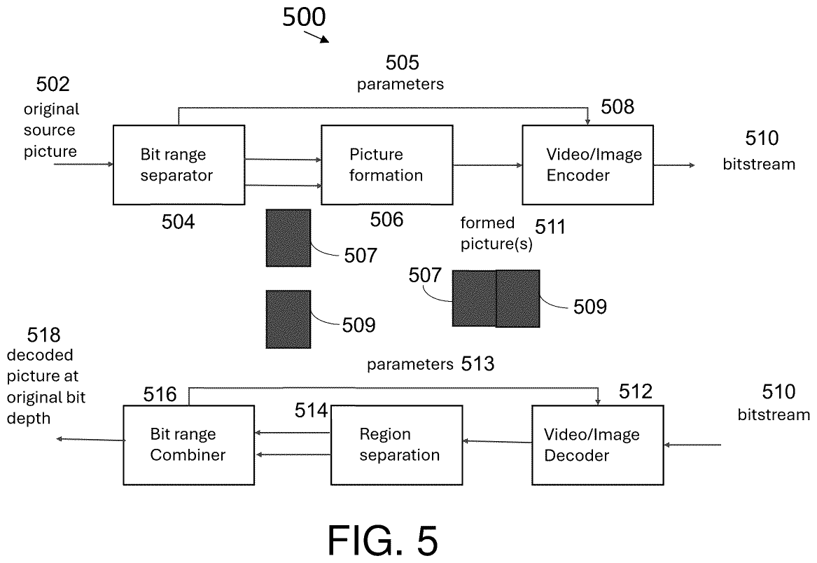

FIG. 5 is a block diagram of a coding and decoding process (or codec 500), based on the examples described herein. Bit range separator 504 takes original source picture 502 as input, and provides parameters 505 to video/image encoder 508. The output of bit range separator 504 is provided to picture formation 506. Picture formation 506 forms one or more formed pictures 511 that include at least picture component 507 associated with a range and picture component 509 associated with a range. The one or more formed pictures 511 are provided to video/image encoder 508 that encodes a coded picture into the bitstream 510 based on parameters 505.

The bitstream 510 is provided as input to video/image decoder 512. Video/image decoder 512 provides parameters 513 to bit range combiner 516. Video/image decoder 512 decodes a coded picture, and an output of the video/image decoder is provided to region separation 514, and the output of region separation 514 is provided to bit range combiner 516. The output of bit range combiner 516, generated based on parameters 513, is a decoded picture at an original bit depth 518.

A clipping function may be implemented as follows:

```
Clip3(min, max, val)
if (val< min)
  return min
if (val> max)
  return max
else
  return val
```

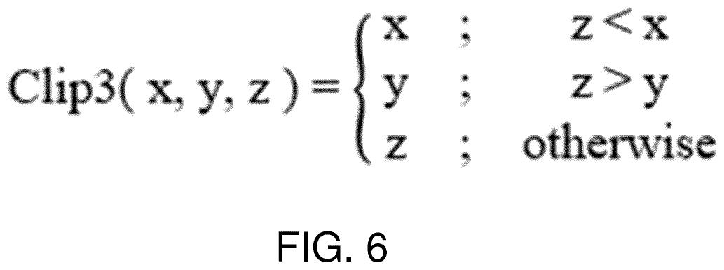

Another clipping function may be implemented as shown in FIG. 6.

The examples described herein could be applied to automotive applications with depth camera/sensors. The examples described herein may be part of the VSEI standard.

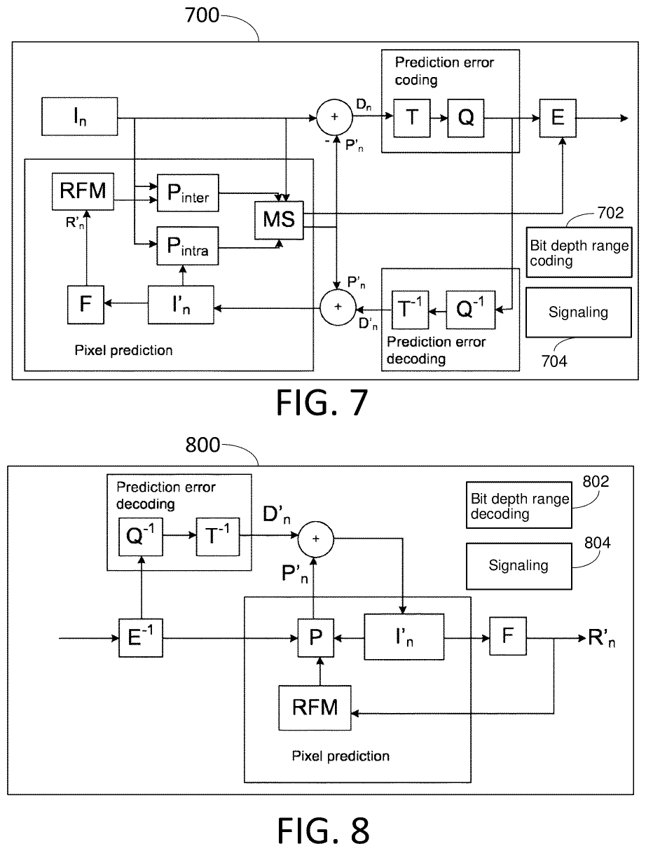

FIG. 7 shows an encoder 700 according to an embodiment. FIG. 7 illustrates an image to be encoded (Iⁿ), a predicted representation of an image block (P′ⁿ), a prediction error signal (Dⁿ), a reconstructed prediction error signal (D′ⁿ), a preliminary reconstructed image (I′ⁿ), a final reconstructed image (R′ⁿ), a transform (T) and inverse transform (T⁻¹), a quantization (Q) and inverse quantization (Q⁻¹), entropy encoding (E), a reference frame memory (RFM), inter prediction (P^{inter}), intra prediction (P^{intra}), mode selection (MS) and filtering (F). Bit depth range coding 702 implements the examples described herein related to bit depth range coding, and signaling 704 implements the encoding-side signaling based on the examples described herein.

FIG. 8 shows a decoder 800 according to an embodiment. FIG. 8 illustrates a predicted representation of an image block (P′ⁿ), a reconstructed prediction error signal (D′ⁿ), a preliminary reconstructed image (I′ⁿ), a final reconstructed image (R′ⁿ), an inverse transform (T⁻¹), an inverse quantization (Q⁻¹), an entropy decoding (E¹), a reference frame memory (RFM), a prediction (either inter or intra) (P), and filtering (F). Bit depth range decoding 802 implements the examples described herein related to bit depth range decoding, and signaling 804 implements the decoding-side signaling based on the examples described herein.

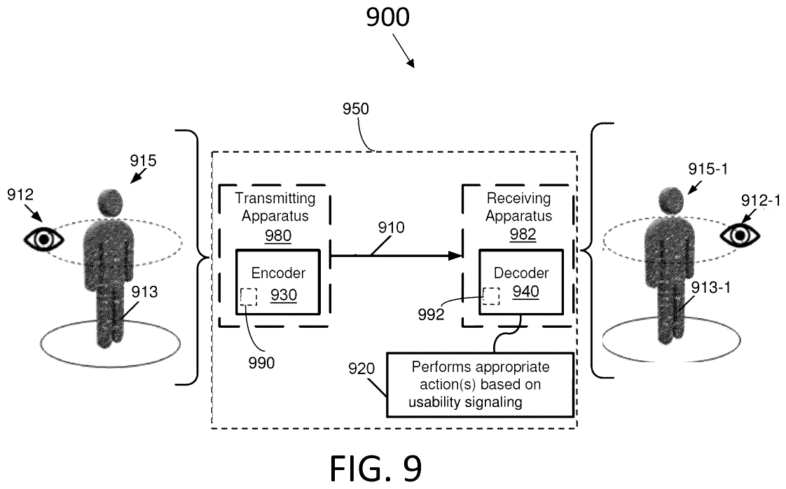

FIG. 9 is a block diagram illustrating a system 900 in accordance with several examples. In an example, the encoder 930 is used to encode an image or video from the scene 915, and the encoder 930 is implemented in a transmitting apparatus 980. The encoder 930 produces a bitstream 910 comprising signaling that is received by the receiving apparatus 982, which implements a decoder 940. The encoder 930 sends the bitstream 910 that comprises the herein described signaling. The decoder 940 forms the image or video for the scene 915-1, and the receiving apparatus 982 would present this to the user, e.g., via a smartphone, television, or projector among many other options.

In some examples, the transmitting apparatus 980 and the receiving apparatus 982 are at least partially within a common apparatus, and for example are located within a common housing 950. In other examples the transmitting apparatus 980 and the receiving apparatus 982 are at least partially not within a common apparatus and have at least partially different housings. Therefore in some examples, the encoder 930 and the decoder 940 are at least partially within a common apparatus, and for example are located within a common housing 950. For example the common apparatus comprising the encoder 930 and decoder 940 implements a codec. In other examples the encoder 930 and the decoder 940 are at least partially not within a common apparatus and have at least partially different housings, but when together still implement a codec.

In some examples, 3D media from the capture (e.g., volumetric capture) at a viewpoint 912 of the scene 915, which includes a person 913) is converted via projection to a series of 2D representations with occupancy, geometry, attributes and/or displacements. Additional atlas information is also included in the bitstream to enable inverse reconstruction. For decoding, the received bitstream 910 is separated into its components with atlas information; occupancy, geometry, displacement, and attribute 2D representations. A 3D reconstruction is performed to reconstruct the scene 915-1 created looking at the viewpoint 912-1 with a “reconstructed” person 913-1. The “-1” are used to indicate that these are reconstructions of the original. As indicated at 920, the decoder 940 performs an action or actions based on the received signaling.

Encoding 990 performs the encoding-side examples described herein related to bit depth range coding. Decoding 992 performs the decoding-side examples described herein related to bit depth range decoding.

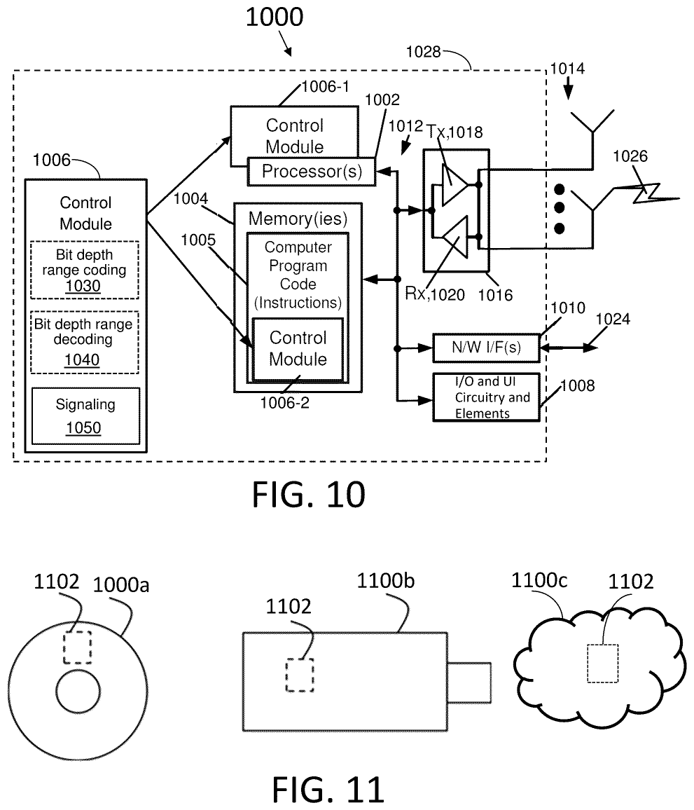

FIG. 10 is an example apparatus 1000, which may be implemented in hardware, configured to implement the examples described herein. The apparatus 1000 comprises at least one processor 1002 (e.g., an FPGA and/or CPU and/or GPU), one or more memories 1004 including computer program code 1005, the computer program code 1005 having instructions to carry out the methods described herein, wherein the at least one memory 1004 and the computer program code 1005 are configured to, with the at least one processor 1002, cause the apparatus 1000 to implement circuitry, a process, component, module, or function (implemented with control module 1006) to implement the examples described herein.

Apparatus 1000 may be a smartphone, personal digital device or assistant, smart television, laptop, pad, tablet, head-mounted display (HMD), or other user device or terminal device. The memory 1004 may be a non-transitory memory, a transitory memory, a volatile memory (e.g. RAM), or a non-volatile memory (e.g., ROM).

Optionally included bit depth range coding 1030 implements the examples described herein related to bit depth range coding, and optionally included bit depth range decoding 1040 implements the examples described herein related to bit depth range decoding. Signaling 1050 implements the signaling described herein.

The apparatus 1000 includes a display and/or I/O interface 1008, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1000 includes one or more communication e.g. network (N/W) interfaces (I/F(s)) 1010. The communication I/F(s) 1010 may be wired and/or wireless and communicate over the Internet/other network(s) via any communication technique including via one or more links 1024. The communication I/F(s) 1010 may comprise one or more transmitters or one or more receivers.

The transceiver 1016 comprises one or more transmitters 1018 and one or more receivers 1020. The transceiver 1016 and/or communication I/F(s) 1010 may comprise standard well-known components such as an amplifier, filter, frequency-converter, (de) modulator, and encoder/decoder circuitries and one or more antennas, such as antennas 1014 used for communication over wireless link 1026.

The control module 1006 of the apparatus 1000 comprises one of or both parts 1006-1 and/or 1006-2, which may be implemented in a number of ways. The control module 1006 may be implemented in hardware as control module 1006-1, such as being implemented as part of the one or more processors 1002. The control module 1006-1 may be implemented also as an integrated circuit or through other hardware such as a programmable gate array. In another example, the control module 1006 may be implemented as control module 1006-2, which is implemented as computer program code (having corresponding instructions) 1005 and is executed by the one or more processors 1002. For instance, the one or more memories 1004 store instructions that, when executed by the one or more processors 1002, cause the apparatus 1000 to perform one or more of the operations as described herein. Furthermore, the one or more processors 1002, one or more memories 1004, and example algorithms (e.g., as flowcharts and/or signaling diagrams), encoded as instructions, programs, or code, are means for causing performance of the operations described herein.

The apparatus 1000 to implement the functionality of control 1006 may correspond to any of the apparatuses depicted herein. Alternatively, apparatus 1000 and its elements may not correspond to any of the other apparatuses depicted herein, as apparatus 1000 may be part of a self-organizing/optimizing network (SON) node or other node, such as a node in a cloud.

The apparatus 1000 may also be distributed throughout the network including within and between apparatus 1000 and any network element (such as a base station and/or terminal device and/or user equipment).

Interface 1012 enables data communication and signaling between the various items of apparatus 1000, as shown in FIG. 10. For example, the interface 1012 may be one or more buses such as address, data, or control buses, and may include any interconnection mechanism, such as a series of lines on a motherboard or integrated circuit, fiber optics or other optical communication equipment, and the like. Computer program code (e.g. instructions) 1005, including control 1006 may comprise object-oriented software configured to pass data or messages between objects within computer program code 1005. Computer program code (e.g. instructions) 1005, including control 1006 may comprise procedural, functional, or scripting code. The apparatus 1000 need not comprise each of the features mentioned, or may comprise other features as well. The various components of apparatus 1000 may at least partially reside in a common housing 1028, or a subset of the various components of apparatus 1000 may at least partially be located in different housings, which different housings may include housing 1028.

FIG. 11 shows a schematic representation of non-volatile memory media 1100a (e.g. computer/compact disc (CD) or digital versatile disc (DVD)) and 1100b (e.g. universal serial bus (USB) memory stick) and 1100c (e.g. cloud storage for downloading instructions and/or parameters 1102 or receiving emailed instructions and/or parameters 1102) storing instructions and/or parameters 1102 which when executed by a processor allows the processor to perform one or more of the operations of the methods described herein. Instructions and/or parameters 1102 may represent or correspond to a non-transitory computer readable medium.

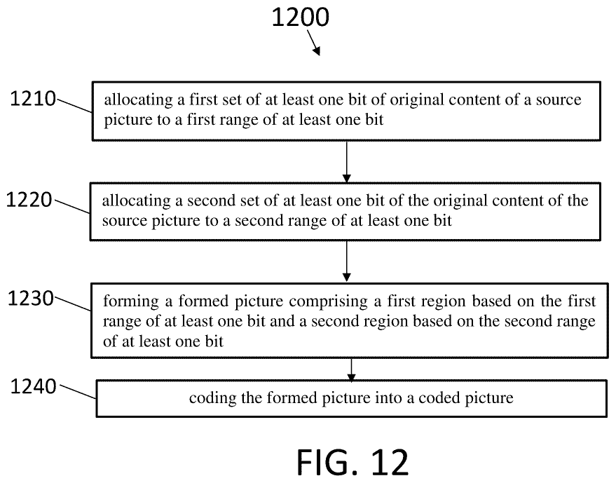

FIG. 12 is an example method 1200, based on the examples described herein. At 1210, the method includes allocating a first set of at least one bit of original content of a source picture to a first range of at least one bit. At 1220, the method includes allocating a second set of at least one bit of the original content of the source picture to a second range of at least one bit. At 1230, the method includes forming a formed picture comprising a first region based on the first range of at least one bit and a second region based on the second range of at least one bit. At 1240, the method includes coding the formed picture into a coded picture. Method 1200 may be performed with codec 500 including video/image encoder 508, encoder 700, transmitting apparatus 980 with encoder 930, or apparatus 1000.

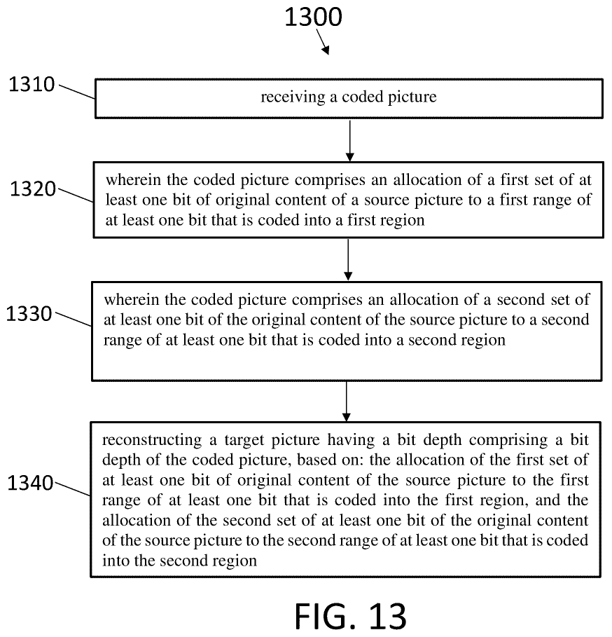

FIG. 13 is an example method 1300, based on the examples described herein. At 1310, the method includes receiving a coded picture. At 1320, the method includes wherein the coded picture comprises an allocation of a first set of at least one bit of original content of a source picture to a first range of at least one bit that is coded into a first region. At 1330, the method includes wherein the coded picture comprises an allocation of a second set of at least one bit of the original content of the source picture to a second range of at least one bit that is coded into a second region. At 1340, the method includes reconstructing a target picture having a bit depth comprising a bit depth of the coded picture, based on: the allocation of the first set of at least one bit of original content of the source picture to the first range of at least one bit that is coded into the first region, and the allocation of the second set of at least one bit of the original content of the source picture to the second range of at least one bit that is coded into the second region. Method 1300 may be performed with codec 500 including video/image decoder 512, decoder 800, receiving apparatus 982 with decoder 940, or apparatus 1000.

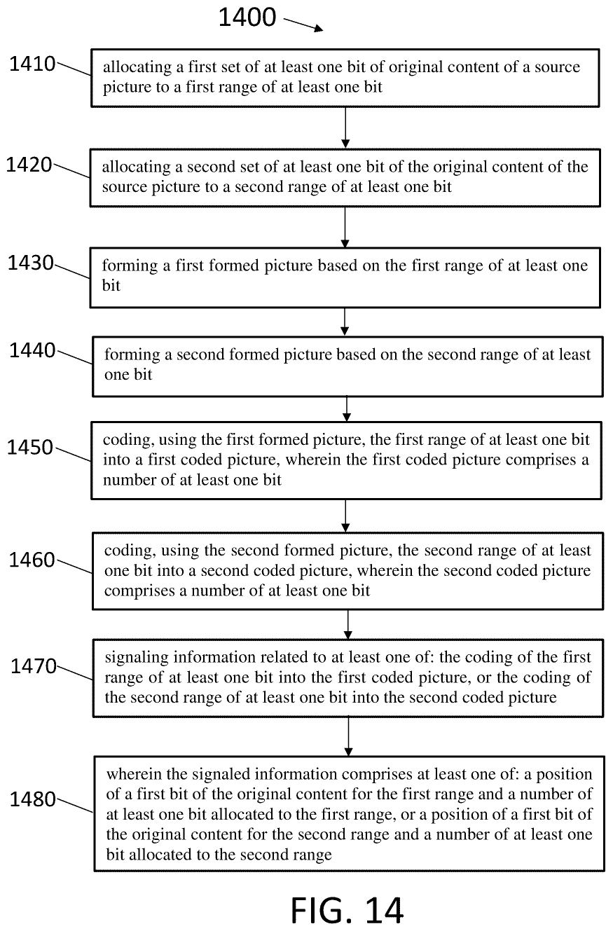

FIG. 14 is an example method 1400, based on the examples described herein. At 1410, the method includes allocating a first set of at least one bit of original content of a source picture to a first range of at least one bit. At 1420, the method includes allocating a second set of at least one bit of the original content of the source picture to a second range of at least one bit. At 1430, the method includes forming a first formed picture based on the first range of at least one bit. At 1440, the method includes forming a second formed picture based on the second range of at least one bit. At 1450, the method includes coding, using the first formed picture, the first range of at least one bit into a first coded picture, wherein the first coded picture comprises a number of at least one bit. At 1460, the method includes coding, using the second formed picture, the second range of at least one bit into a second coded picture, wherein the second coded picture comprises a number of at least one bit. At 1470, the method includes signaling information related to at least one of: the coding of the first range of at least one bit into the first coded picture, or the coding of the second range of at least one bit into the second coded picture. At 1480, the method includes wherein the signaled information comprises at least one of: a position of a first bit of the original content for the first range and a number of at least one bit allocated to the first range, or a position of a first bit of the original content for the second range and a number of at least one bit allocated to the second range. Method 1400 may be performed with codec 500 including video/image encoder 508, encoder 700, transmitting apparatus 980 with encoder 930, or apparatus 1000.

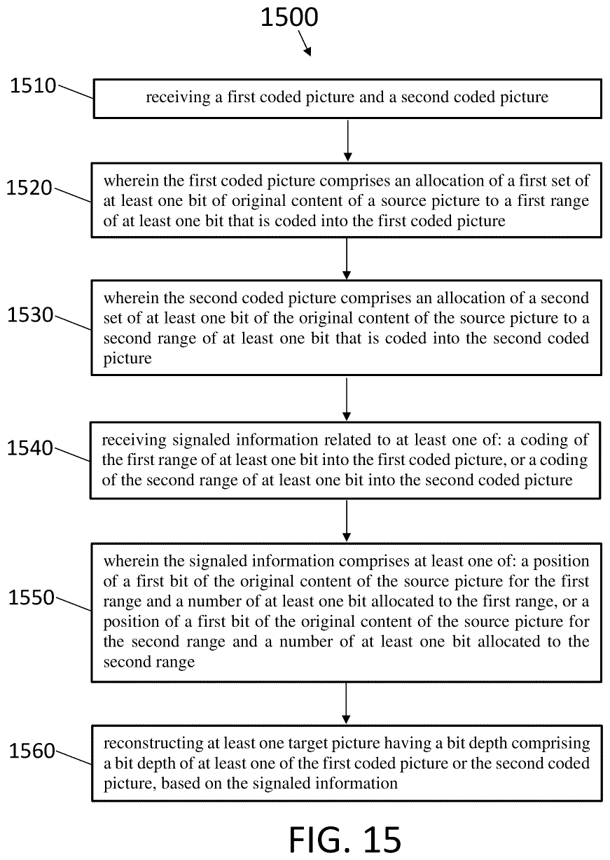

FIG. 15 is an example method 1500, based on the examples described herein. At 1510, the method includes receiving a first coded picture and a second coded picture. At 1520, the method includes wherein the first coded picture comprises an allocation of a first set of at least one bit of original content of a source picture to a first range of at least one bit that is coded into the first coded picture. At 1530, the method includes wherein the second coded picture comprises an allocation of a second set of at least one bit of the original content of the source picture to a second range of at least one bit that is coded into the second coded picture. At 1540, the method includes receiving signaled information related to at least one of: a coding of the first range of at least one bit into the first coded picture, or a coding of the second range of at least one bit into the second coded picture. At 1550, the method includes wherein the signaled information comprises at least one of: a position of a first bit of the original content of the source picture for the first range and a number of at least one bit allocated to the first range, or a position of a first bit of the original content of the source picture for the second range and a number of at least one bit allocated to the second range. At 1560, the method includes reconstructing at least one target picture having a bit depth comprising a bit depth of at least one of the first coded picture or the second coded picture, based on the signaled information. Method 1500 may be performed with codec 500 including video/image decoder 512, decoder 800, receiving apparatus 982 with decoder 940, or apparatus 1000.

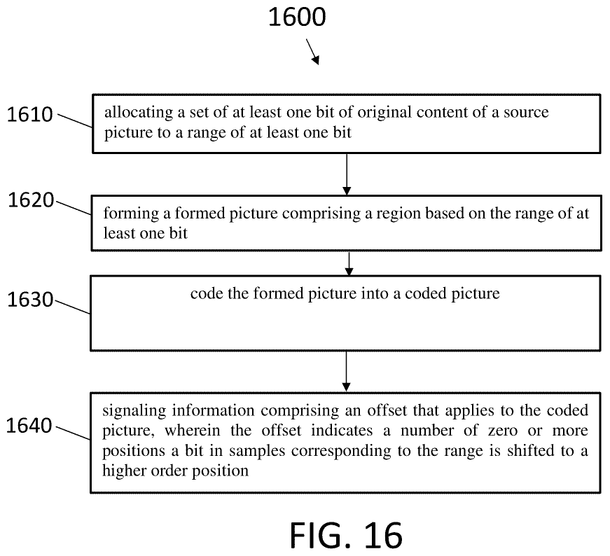

FIG. 16 is an example method 1600, based on the examples described herein. At 1610, the method includes allocating a set of at least one bit of original content of a source picture to a range of at least one bit. At 1620, the method includes forming a formed picture comprising a region based on the range of at least one bit. At 1630, the method includes coding the formed picture into a coded picture. At 1640, the method includes signaling information comprising an offset that applies to the coded picture, wherein the offset indicates a number of zero or more positions a bit in samples corresponding to the range is shifted to a higher order position. Method 1600 may be performed with codec 500 including video/image encoder 508, encoder 700, transmitting apparatus 980 with encoder 930, or apparatus 1000.

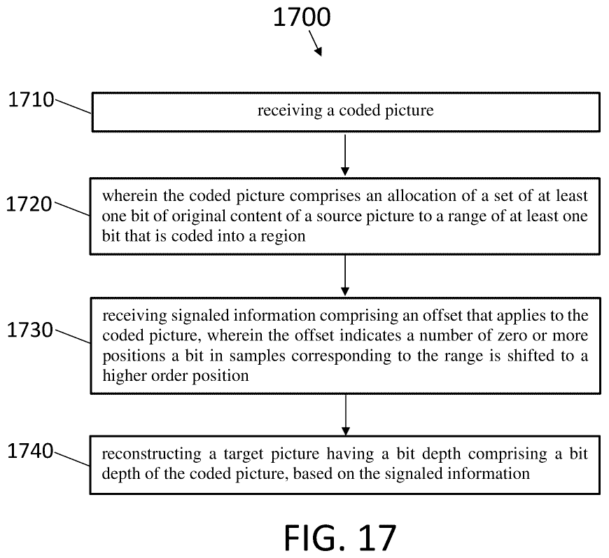

FIG. 17 is an example method 1700, based on the examples described herein. At 1710, the method includes receiving a coded picture. At 1720, the method includes wherein the coded picture comprises an allocation of a set of at least one bit of original content of a source picture to a range of at least one bit that is coded into a region. At 1730, the method includes receiving signaled information comprising an offset that applies to the coded picture, wherein the offset indicates a number of zero or more positions a bit in samples corresponding to the range is shifted to a higher order position. At 1740, the method includes reconstructing a target picture having a bit depth comprising a bit depth of the coded picture, based on the signaled information. Method 1700 may be performed with codec 500 including video/image decoder 512, decoder 800, receiving apparatus 982 with decoder 940, or apparatus 1000.

The following examples are provided and described herein.

Example 1. An apparatus including: at least one processor; and at least one memory storing instructions that, when executed by the at least one processor, cause the apparatus at least to: allocate a first set of at least one bit of original content of a source picture to a first range of at least one bit; allocate a second set of at least one bit of the original content of the source picture to a second range of at least one bit; form a formed picture comprising a first region based on the first range of at least one bit and a second region based on the second range of at least one bit; code the formed picture into a coded picture.

Example 2. The apparatus of example 1, wherein the apparatus is further caused to: signal information related to at least one of: the coding of the first range of at least one bit into the first region, or the coding of the second range of at least one bit into the second region.

Example 3. The apparatus of example 2, wherein the signaled information comprises at least one of: a position of a first bit of the original content for the first range and a number of at least one bit allocated to the first range, or a position of a first bit of the original content for the second range and a number of at least one bit allocated to the second range.

Example 4. The apparatus of example 2, wherein the signaled information is signaled with at least one supplemental enhancement information message syntax element.

Example 5. The apparatus of example 1, wherein: the first set of at least one bit of the original content of the source picture allocated to the first range of at least one bit comprises a number of most significant bits of the original content of the source picture, and the second set of at least one bit of the original content of the source picture allocated to the second range of at least one bit comprises a number of less significant bits of the original content of the source picture.

Example 6. The apparatus of example 1, wherein: a first plurality of bits of the original content of the source picture of the first set of at least one bit allocated to the first range of at least one bit are contiguous, and a second plurality of bits of the original content of the source picture of the second set of at least one bit allocated to the second range of at least one bit are contiguous.

Example 7. The apparatus of example 1, wherein the apparatus is further caused to: composite the first range of at least one bit and the second range of at least one bit within the coded picture using at least one subpicture or at least one constituent rectangle.

Example 8. The apparatus of example 7, wherein the apparatus is further caused to: signal information comprising a specific subpicture index or constituent rectangle index associated with the composite of the first range of at least one bit and the second range of at least one bit.

Example 9. The apparatus of example 1, wherein the apparatus is further caused to: signal an offset that applies to the coded picture, wherein the offset indicates a number of zero or more positions a bit in samples corresponding to the first range or the second range is shifted to a higher order position.

Example 10. The apparatus of example 1, wherein the apparatus is further caused to: signal information comprising an indication of: a beginning of the first range of at least one bit that is coded into the first region, or a beginning of the second range of at least one bit that is coded into the second region.

Example 11. The apparatus of example 1, wherein the apparatus is further caused to: signal a bit depth of the original content of the source picture.

Example 12. The apparatus of example 1, wherein the apparatus is further caused to: discard at least one bit of the original content of the source picture, such that the at least one bit of the original content of the source picture that is discarded is not allocated to the first range of at least one bit or to the second range of at least one bit.

Example 13. The apparatus of example 1, wherein a number of at least one bit of the coded picture is less than a number of bits used to represent the original content of the source picture.

Example 14. The apparatus of example 1, wherein the apparatus is further caused to: signal information comprising a subpicture identifier or a constituent rectangle identifier that is used to indicate: a location of the first region where the first range is coded, or a location of the second region where the second range is coded.

Example 15. The apparatus of example 1, wherein the apparatus is further caused to: signal information comprising a layer identifier with a subpicture identifier or a constituent rectangle identifier that indicate: a location of the first region where the first range is coded, or a location of the second region where the second range is coded; wherein the location of the first region where the first range is coded corresponds to the layer identifier, or the location of the second region where the second range is coded corresponds to the layer identifier.

Example 16. An apparatus including: at least one processor; and at least one memory storing instructions that, when executed by the at least one processor, cause the apparatus at least to: receive a coded picture; wherein the coded picture comprises an allocation of a first set of at least one bit of original content of a source picture to a first range of at least one bit that is coded into a first region; wherein the coded picture comprises an allocation of a second set of at least one bit of the original content of the source picture to a second range of at least one bit that is coded into a second region; and reconstruct a target picture having a bit depth comprising a bit depth of the coded picture, based on: the allocation of the first set of at least one bit of original content of the source picture to the first range of at least one bit that is coded into the first region, and the allocation of the second set of at least one bit of the original content of the source picture to the second range of at least one bit that is coded into the second region.

Example 17. The apparatus of example 16, wherein the apparatus is further caused to: receive signaled information related to at least one of: a coding of the first range of at least one bit into the first region, or a coding of the second range of at least one bit into the second region, wherein the target picture is reconstructed based on the signaled information.

Example 18. The apparatus of example 17, wherein the signaled information comprises at least one of: a position of a first bit of the original content of the source picture for the first range and a number of at least one bit allocated to the first range, or a position of a first bit of the original content of the source picture for the second range and a number of at least one bit allocated to the second range.

Example 19. The apparatus of example 17, wherein the signaled information is received with at least one supplemental enhancement information message syntax element.

Example 20. The apparatus of example 16, wherein: the first set of at least one bit of the original content of the source picture allocated to the first range of at least one bit comprises a number of most significant bits of the original content of the source picture, and the second set of at least one bit of the original content of the source picture allocated to the second range of at least one bit comprises a number of less significant bits of the original content of the source picture.

Example 21. The apparatus of example 16, wherein: a first plurality of bits of the original content of the source picture of the first set of at least one bit allocated to the first range of at least one bit are contiguous, and a second plurality of bits of the original content of the source picture of the second set of at least one bit allocated to the second range of at least one bit are contiguous.

Example 22. The apparatus of example 16, wherein the first range of at least one bit and the second range of at least one bit are composited within the coded picture using at least one subpicture or at least one constituent rectangle.

Example 23. The apparatus of example 22, wherein the apparatus is further caused to: receive signaled information comprising a specific subpicture index or constituent rectangle index associated with the compositing of the first range of at least one bit and the second range of at least one bit; wherein the target picture is reconstructed based on the signaled information.

Example 24. The apparatus of example 16, wherein the apparatus is further caused to: received signaled information comprising an offset that applies to the coded picture, wherein the offset indicates a number of zero or more positions a bit in samples corresponding to the first range or the second range is shifted to a higher order position; wherein the target picture is reconstructed based on the signaled information.

Example 25. The apparatus of example 16, wherein the apparatus is further caused to: receive signaled information comprising an indication of: a beginning of the first range of at least one bit that is coded into the first region, or a beginning of the second range of at least one bit that is coded into the second region; wherein the target picture is reconstructed based on the signaled information.

Example 26. The apparatus of example 16, wherein the apparatus is further caused to: receive signaling of a bit depth of the original content of the source picture; wherein the target picture is reconstructed based on the signaling of the bit depth of the original content of the source picture.

Example 27. The apparatus of example 16, wherein at least one bit of the original content of the source picture is discarded, such that the at least one bit of the original content of the source picture that is discarded is not allocated to the first range of at least one bit or to the second range of at least one bit.

Example 28. The apparatus of example 16, wherein a number of at least one bit of the coded picture is less than a number of bits used to represent the original content of the source picture.

Example 29. The apparatus of example 16, wherein the apparatus is further caused to: received signaled information comprising a subpicture identifier or a constituent rectangle identifier that is used to indicate: a location of the first region where the first range is coded, or a location of the second region where the second range is coded; wherein the target picture is reconstructed based on the signaled information.

Example 30. The apparatus of example 16, wherein the apparatus is further caused to: receive signaled information comprising a layer identifier with a subpicture identifier or a constituent rectangle identifier that indicate: a location of the first region where the first range is coded, or a location of the second region where the second range is coded; wherein the location of the first region where the first range is coded corresponds to the layer identifier, or the location of the second region where the second range is coded corresponds to the layer identifier; wherein the target picture is reconstructed based on the signaled information.

Example 31. The apparatus of example 16, wherein the apparatus is further caused to, for the first range or the second range: determine an adjusted decoded sample based on a minimum number of bits for the first range or the second range, a maximum number of bits for the first range or the second range, and a value determined based on a decoded sample and rounding offset; wherein the adjusted decoded sample is not less than the minimum number of bits for the first range and not greater than the maximum number of bits for the first range, or the adjusted decoded sample is not less than the minimum number of bits for the second range and not greater than the maximum number of bits for the second range; wherein the target picture is reconstructed based on the adjusted decoded sample.

Example 32. An apparatus including: at least one processor; and at least one memory storing instructions that, when executed by the at least one processor, cause the apparatus at least to: allocate a first set of at least one bit of original content of a source picture to a first range of at least one bit; allocate a second set of at least one bit of the original content of the source picture to a second range of at least one bit; form a first formed picture based on the first range of at least one bit; form a second formed picture based on the second range of at least one bit; code, using the first formed picture, the first range of at least one bit into a first coded picture, wherein the first coded picture comprises a number of at least one bit; code, using the second formed picture, the second range of at least one bit into a second coded picture, wherein the second coded picture comprises a number of at least one bit; and signal information related to at least one of: the coding of the first range of at least one bit into the first coded picture, or the coding of the second range of at least one bit into the second coded picture; wherein the signaled information comprises at least one of: a position of a first bit of the original content for the first range and a number of at least one bit allocated to the first range, or a position of a first bit of the original content for the second range and a number of at least one bit allocated to the second range. In one variant of example 32, the number of at least one bit of the first coded picture is the same as the number of at least one bit of the second coded picture. In another variant of example 32, the number of at least one bit of the first coded picture is different from the number of at least one bit of the second coded picture.

Example 33. The apparatus of example 32, wherein the signaled information comprises an offset that applies to the first coded picture or the second coded picture, wherein the offset indicates a number of zero or more positions a bit in samples corresponding to the first range or the second range is shifted to a higher order position.

Example 34. An apparatus including: at least one processor; and at least one memory storing instructions that, when executed by the at least one processor, cause the apparatus at least to: receive a first coded picture and a second coded picture; wherein the first coded picture comprises an allocation of a first set of at least one bit of original content of a source picture to a first range of at least one bit that is coded into the first coded picture; wherein the second coded picture comprises an allocation of a second set of at least one bit of the original content of the source picture to a second range of at least one bit that is coded into the second coded picture; receive signaled information related to at least one of: a coding of the first range of at least one bit into the first coded picture, or a coding of the second range of at least one bit into the second coded picture; wherein the signaled information comprises at least one of: a position of a first bit of the original content of the source picture for the first range and a number of at least one bit allocated to the first range, or a position of a first bit of the original content of the source picture for the second range and a number of at least one bit allocated to the second range; and reconstruct at least one target picture having a bit depth comprising a bit depth of at least one of the first coded picture or the second coded picture, based on the signaled information.

Example 35. The apparatus of example 34, wherein the signaled information comprises an offset that applies to the first coded picture or the second coded picture, wherein the offset indicates a number of zero or more positions a bit in samples corresponding to the first range or the second range is shifted to a higher order position.

Example 36. The apparatus of example 34, wherein the apparatus is further caused to, for the first range or the second range: determine an adjusted decoded sample based on a minimum number of bits for the first range or the second range, a maximum number of bits for the first range or the second range, and a value determined based on a decoded sample and rounding offset; wherein the adjusted decoded sample is not less than the minimum number of bits for the first range and not greater than the maximum number of bits for the first range, or the adjusted decoded sample is not less than the minimum number of bits for the second range and not greater than the maximum number of bits for the second range; wherein the target picture is reconstructed based on the adjusted decoded sample.

Example 37. An apparatus including: at least one processor; and at least one memory storing instructions that, when executed by the at least one processor, cause the apparatus at least to: allocate a set of at least one bit of original content of a source picture to a range of at least one bit; form a formed picture comprising a region based on the range of at least one bit; code the formed picture into a coded picture; and signal information comprising an offset that applies to the coded picture, wherein the offset indicates a number of zero or more positions a bit in samples corresponding to the range is shifted to a higher order position.

Example 38. An apparatus including: at least one processor; and at least one memory storing instructions that, when executed by the at least one processor, cause the apparatus at least to: receive a coded picture; wherein the coded picture comprises an allocation of a set of at least one bit of original content of a source picture to a range of at least one bit that is coded into a region; receive signaled information comprising an offset that applies to the coded picture, wherein the offset indicates a number of zero or more positions a bit in samples corresponding to the range is shifted to a higher order position; and reconstruct a target picture having a bit depth comprising a bit depth of the coded picture, based on the signaled information.

Example 39. The apparatus of example 38, wherein the apparatus is further caused to, for the range: determine an adjusted decoded sample based on a minimum number of bits for the range, a maximum number of bits for the range, and a value determined based on a decoded sample and rounding offset; wherein the adjusted decoded sample is not less than the minimum number of bits for the range and not greater than the maximum number of bits for the range; wherein the target picture is reconstructed based on the adjusted decoded sample.

Example 40. A method including: allocating a first set of at least one bit of original content of a source picture to a first range of at least one bit; allocating a second set of at least one bit of the original content of the source picture to a second range of at least one bit; forming a formed picture comprising a first region based on the first range of at least one bit and a second region based on the second range of at least one bit; coding the formed picture into a coded picture.

Example 41. A method including: receiving a coded picture; wherein the coded picture comprises an allocation of a first set of at least one bit of original content of a source picture to a first range of at least one bit that is coded into a first region; wherein the coded picture comprises an allocation of a second set of at least one bit of the original content of the source picture to a second range of at least one bit that is coded into a second region; and reconstructing a target picture having a bit depth comprising a bit depth of the coded picture, based on: the allocation of the first set of at least one bit of original content of the source picture to the first range of at least one bit that is coded into the first region, and the allocation of the second set of at least one bit of the original content of the source picture to the second range of at least one bit that is coded into the second region.

Example 42. A method including: allocating a first set of at least one bit of original content of a source picture to a first range of at least one bit; allocating a second set of at least one bit of the original content of the source picture to a second range of at least one bit; forming a first formed picture based on the first range of at least one bit; forming a second formed picture based on the second range of at least one bit; coding, using the first formed picture, the first range of at least one bit into a first coded picture, wherein the first coded picture comprises a number of at least one bit; coding, using the second formed picture, the second range of at least one bit into a second coded picture, wherein the second coded picture comprises a number of at least one bit; and signaling information related to at least one of: the coding of the first range of at least one bit into the first coded picture, or the coding of the second range of at least one bit into the second coded picture; wherein the signaled information comprises at least one of: a position of a first bit of the original content for the first range and a number of at least one bit allocated to the first range, or a position of a first bit of the original content for the second range and a number of at least one bit allocated to the second range. In one variant of example 42, the number of at least one bit of the first coded picture is the same as the number of at least one bit of the second coded picture. In another variant of example 42, the number of at least one bit of the first coded picture is different from the number of at least one bit of the second coded picture.

Example 43. A method including: receiving a first coded picture and a second coded picture; wherein the first coded picture comprises an allocation of a first set of at least one bit of original content of a source picture to a first range of at least one bit that is coded into the first coded picture; wherein the second coded picture comprises an allocation of a second set of at least one bit of the original content of the source picture to a second range of at least one bit that is coded into the second coded picture; receiving signaled information related to at least one of: a coding of the first range of at least one bit into the first coded picture, or a coding of the second range of at least one bit into the second coded picture; wherein the signaled information comprises at least one of: a position of a first bit of the original content of the source picture for the first range and a number of at least one bit allocated to the first range, or a position of a first bit of the original content of the source picture for the second range and a number of at least one bit allocated to the second range; and reconstructing at least one target picture having a bit depth comprising a bit depth of at least one of the first coded picture or the second coded picture, based on the signaled information.

Example 44. A method including: allocating a set of at least one bit of original content of a source picture to a range of at least one bit; forming a formed picture comprising a region based on the range of at least one bit; coding the formed picture into a coded picture; and signaling information comprising an offset that applies to the coded picture, wherein the offset indicates a number of zero or more positions a bit in samples corresponding to the range is shifted to a higher order position.

Example 45. A method including: receiving a coded picture; wherein the coded picture comprises an allocation of a set of at least one bit of original content of a source picture to a range of at least one bit that is coded into a region; receiving signaled information comprising an offset that applies to the coded picture, wherein the offset indicates a number of zero or more positions a bit in samples corresponding to the range is shifted to a higher order position; and reconstructing a target picture having a bit depth comprising a bit depth of the coded picture, based on the signaled information.

Example 46. An apparatus including: means for allocating a first set of at least one bit of original content of a source picture to a first range of at least one bit; means for allocating a second set of at least one bit of the original content of the source picture to a second range of at least one bit; means for forming a formed picture comprising a first region based on the first range of at least one bit and a second region based on the second range of at least one bit; means for coding the formed picture into a coded picture.

Example 47. An apparatus including: means for receiving a coded picture; wherein the coded picture comprises an allocation of a first set of at least one bit of original content of a source picture to a first range of at least one bit that is coded into a first region; wherein the coded picture comprises an allocation of a second set of at least one bit of the original content of the source picture to a second range of at least one bit that is coded into a second region; and means for reconstructing a target picture having a bit depth comprising a bit depth of the coded picture, based on: the allocation of the first set of at least one bit of original content of the source picture to the first range of at least one bit that is coded into the first region, and the allocation of the second set of at least one bit of the original content of the source picture to the second range of at least one bit that is coded into the second region.

Example 48. An apparatus including: means for allocating a first set of at least one bit of original content of a source picture to a first range of at least one bit; means for allocating a second set of at least one bit of the original content of the source picture to a second range of at least one bit; means for forming a first formed picture based on the first range of at least one bit; means for forming a second formed picture based on the second range of at least one bit; means for coding, using the first formed picture, the first range of at least one bit into a first coded picture, wherein the first coded picture comprises a number of at least one bit; means for coding, using the second formed picture, the second range of at least one bit into a second coded picture, wherein the second coded picture comprises a number of at least one bit; and means for signaling information related to at least one of: the coding of the first range of at least one bit into the first coded picture, or the coding of the second range of at least one bit into the second coded picture; wherein the signaled information comprises at least one of: a position of a first bit of the original content for the first range and a number of at least one bit allocated to the first range, or a position of a first bit of the original content for the second range and a number of at least one bit allocated to the second range.

Example 49. An apparatus including: means for receiving a first coded picture and a second coded picture; wherein the first coded picture comprises an allocation of a first set of at least one bit of original content of a source picture to a first range of at least one bit that is coded into the first coded picture; wherein the second coded picture comprises an allocation of a second set of at least one bit of the original content of the source picture to a second range of at least one bit that is coded into the second coded picture; means for receiving signaled information related to at least one of: a coding of the first range of at least one bit into the first coded picture, or a coding of the second range of at least one bit into the second coded picture; wherein the signaled information comprises at least one of: a position of a first bit of the original content of the source picture for the first range and a number of at least one bit allocated to the first range, or a position of a first bit of the original content of the source picture for the second range and a number of at least one bit allocated to the second range; and means for reconstructing at least one target picture having a bit depth comprising a bit depth of at least one of the first coded picture or the second coded picture, based on the signaled information.

Example 50. An apparatus including: means for allocating a set of at least one bit of original content of a source picture to a range of at least one bit; means for forming a formed picture comprising a region based on the range of at least one bit; means for coding the formed picture into a coded picture; and means for signaling information comprising an offset that applies to the coded picture, wherein the offset indicates a number of zero or more positions a bit in samples corresponding to the range is shifted to a higher order position.

Example 51. An apparatus including: means for receiving a coded picture; wherein the coded picture comprises an allocation of a set of at least one bit of original content of a source picture to a range of at least one bit that is coded into a region; means for receiving signaled information comprising an offset that applies to the coded picture, wherein the offset indicates a number of zero or more positions a bit in samples corresponding to the range is shifted to a higher order position; and means for reconstructing a target picture having a bit depth comprising a bit depth of the coded picture, based on the signaled information.

Example 52. A computer readable medium including instructions stored thereon for performing at least the following: allocating a first set of at least one bit of original content of a source picture to a first range of at least one bit; allocating a second set of at least one bit of the original content of the source picture to a second range of at least one bit; forming a formed picture comprising a first region based on the first range of at least one bit and a second region based on the second range of at least one bit; coding the formed picture into a coded picture.

Example 53. A computer readable medium including instructions stored thereon for performing at least the following: receiving a coded picture; wherein the coded picture comprises an allocation of a first set of at least one bit of original content of a source picture to a first range of at least one bit that is coded into a first region; wherein the coded picture comprises an allocation of a second set of at least one bit of the original content of the source picture to a second range of at least one bit that is coded into a second region; and reconstructing a target picture having a bit depth comprising a bit depth of the coded picture, based on: the allocation of the first set of at least one bit of original content of the source picture to the first range of at least one bit that is coded into the first region, and the allocation of the second set of at least one bit of the original content of the source picture to the second range of at least one bit that is coded into the second region.

Example 54. A computer readable medium including instructions stored thereon for performing at least the following: allocating a first set of at least one bit of original content of a source picture to a first range of at least one bit; allocating a second set of at least one bit of the original content of the source picture to a second range of at least one bit; forming a first formed picture based on the first range of at least one bit; forming a second formed picture based on the second range of at least one bit; coding, using the first formed picture, the first range of at least one bit into a first coded picture, wherein the first coded picture comprises a number of at least one bit; coding, using the second formed picture, the second range of at least one bit into a second coded picture, wherein the second coded picture comprises a number of at least one bit; and signaling information related to at least one of: the coding of the first range of at least one bit into the first coded picture, or the coding of the second range of at least one bit into the second coded picture; wherein the signaled information comprises at least one of: a position of a first bit of the original content for the first range and a number of at least one bit allocated to the first range, or a position of a first bit of the original content for the second range and a number of at least one bit allocated to the second range.

Example 55. A computer readable medium including instructions stored thereon for performing at least the following: receiving a first coded picture and a second coded picture; wherein the first coded picture comprises an allocation of a first set of at least one bit of original content of a source picture to a first range of at least one bit that is coded into the first coded picture; wherein the second coded picture comprises an allocation of a second set of at least one bit of the original content of the source picture to a second range of at least one bit that is coded into the second coded picture; receiving signaled information related to at least one of: a coding of the first range of at least one bit into the first coded picture, or a coding of the second range of at least one bit into the second coded picture; wherein the signaled information comprises at least one of: a position of a first bit of the original content of the source picture for the first range and a number of at least one bit allocated to the first range, or a position of a first bit of the original content of the source picture for the second range and a number of at least one bit allocated to the second range; and reconstructing at least one target picture having a bit depth comprising a bit depth of at least one of the first coded picture or the second coded picture, based on the signaled information.

Example 56. A computer readable medium including instructions stored thereon for performing at least the following: allocating a set of at least one bit of original content of a source picture to a range of at least one bit; forming a formed picture comprising a region based on the range of at least one bit; coding the formed picture into a coded picture; and signaling information comprising an offset that applies to the coded picture, wherein the offset indicates a number of zero or more positions a bit in samples corresponding to the range is shifted to a higher order position.

Example 57. A computer readable medium including instructions stored thereon for performing at least the following: receiving a coded picture; wherein the coded picture comprises an allocation of a set of at least one bit of original content of a source picture to a range of at least one bit that is coded into a region; receiving signaled information comprising an offset that applies to the coded picture, wherein the offset indicates a number of zero or more positions a bit in samples corresponding to the range is shifted to a higher order position; and reconstructing a target picture having a bit depth comprising a bit depth of the coded picture, based on the signaled information.

In the above, some embodiments have been described with reference to SEI messages. It needs to be understood that embodiments may be similarly realized with any other similar syntax structures, such as metadata OBUs.

In the above, some embodiments have been described with reference to SEI messages and some embodiments describe a sample reconstruction performed as post-processing to decoding. It is to be understood that embodiments may be similarly realized with any syntax structures, such as parameter sets, which may imply normative decoding. Furthermore, embodiments may be similarly realized when the sample reconstruction is performed normatively to reconstruct pictures that are normatively output by the decoder and/or may be used as reference pictures for predicting other pictures.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, some embodiments have been described in relation to particular syntax elements and/or syntax structures. It needs to be understood that corresponding embodiments for encoding may be realized by including encoding steps for creating the particular syntax elements and/or syntax structures. Similarly, it needs to be understood that corresponding embodiments for decoding may be realized by including decoding steps for reading the particular syntax elements and/or syntax structures. Furthermore, when the decoded syntax elements and/or syntax structures imply certain processing, such as certain processing order of SEI messages, corresponding embodiments for decoding may include such processing steps.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

The term “non-transitory,” as used herein, is a limitation of the medium itself (i.e., tangible, not a signal) as opposed to a limitation on data storage persistency (e.g., RAM vs. ROM).

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (-), or number (or abbreviations having a character may be the same with a character removed), and may be case insensitive):
2D two-dimensional
3D three-dimensional
ASIC application specific integrated circuit
BRI bitdepth range information
Cb blue chrominance component
Cg green chrominance component
Co orange chrominance component
CPU central processing unit
Cr red chrominance
CR constituent rectangle
CVS coded video sequence
Exp exponential
FPGA field programmable gate array
H.2xx family of video coding standards in the domain of the ITU-T (e.g. H.265, H.266, H.274)
HDR high dynamic range
HEVC high efficiency video coding
HMD head-mounted display
ID identifier
IEC International Electrotechnical Commission
I/F interface
I/O input/output
ISO International Organization for Standardization
ITU-T International Telecommunication Union Telecommunication Standardization Sector
JCTVC Joint Collaborative Team on Video Coding
JTC Joint Technical Committee
LSB least significant bit
MSB most significant bit
MPEG-H MPEG high efficiency
MPEG-I MPEG immersive
NAL network abstraction layer
N/W network
NUH NAL unit header
pps picture parameter set
PU prediction unit
QP quantization parameter
RAM random access memory
Rect rectangle
ROM read only memory
SC subcommittee
SEI supplemental enhancement information
SON self-organizing/optimizing network
sps sequence parameter set
ue(v) unsigned integer Exp-Golomb-coded syntax element with the left bit first
UI user interface
u(n) unsigned integer using n bits (e.g., u(4))
USB universal serial bus
u(v) unsigned integer using a variable length number of bits
VSEI versatile supplemental enhancement information
VVC versatile video coding
WG working group

What is claimed is:

1. An apparatus comprising:
at least one processor; and
at least one memory storing instructions that, when executed by the at least one processor, cause the apparatus at least to:
allocate a first set of at least one bit of an original content of a source picture to a first range of at least one bit;
form a formed picture comprising a first region based on the first range of at least one bit; and
code the formed picture into a coded picture.

2. The apparatus of claim 1, the apparatus is further caused to:
allocate a second set of at least one bit of the original content of the source picture to a second range of at least one bit;
wherein the formed picture further comprises a second region based on the second range of at least one bit.

3. The apparatus of claim 2, wherein the apparatus is further caused to:
signal information related to at least one of: the coding of the first range of at least one bit into the first region, or the coding of the second range of at least one bit into the second region.

4. The apparatus of claim 3, wherein the signaled information comprises at least one of: a position of a first bit of the original content for the first range and a number of at least one bit allocated to the first range, or a position of a first bit of the original content for the second range and a number of at least one bit allocated to the second range.

5. The apparatus of claim 2, wherein:
the first set of at least one bit of the original content of the source picture allocated to the first range of at least one bit comprises a number of most significant bits of the original content of the source picture, and
the second set of at least one bit of the original content of the source picture allocated to the second range of at least one bit comprises a number of less significant bits of the original content of the source picture.

6. The apparatus of claim 2, wherein the apparatus is further caused to:
composite the first range of at least one bit and the second range of at least one bit within the coded picture using at least one subpicture or at least one constituent rectangle.

7. The apparatus of claim 2, wherein the apparatus is further caused to:
signal an offset that applies to the coded picture, wherein the offset indicates a number of zero or more positions a bit in samples corresponding to the first range or the second range is shifted to a higher order position.

8. The apparatus of claim 2, wherein the apparatus is further caused to:
signal information comprising an indication of: a beginning of the first range of at least one bit that is coded into the first region, or a beginning of the second range of at least one bit that is coded into the second region.

9. The apparatus of claim 2, wherein the apparatus is further caused to:
discard at least one bit of the original content of the source picture, such that the at least one bit of the original content of the source picture that is discarded is not allocated to the first range of at least one bit or to the second range of at least one bit.

10. An apparatus comprising:
at least one processor; and
at least one memory storing instructions that, when executed by the at least one processor, cause the apparatus at least to:
receive a coded picture;
wherein the coded picture comprises an allocation of a first set of at least one bit of an original content of a source picture to a first range of at least one bit that is coded into a first region; and
reconstruct a target picture having a bit depth comprising a bit depth of the coded picture, based on: the allocation of the first set of at least one bit of original content of the source picture to the first range of at least one bit that is coded into the first region.

11. The apparatus of claim 10:
wherein the coded picture comprises an allocation of a second set of at least one bit of the original content of the source picture to a second range of at least one bit that is coded into a second region; and
wherein the target picture is reconstructed based on the allocation of the second set of at least one bit of the original content of the source picture to the second range of at least one bit that is coded into the second region.

12. The apparatus of claim 11, wherein the apparatus is further caused to:
receive signaled information related to at least one of: a coding of the first range of at least one bit into the first region, or a coding of the second range of at least one bit into the second region, wherein the target picture is reconstructed based on the signaled information.

13. The apparatus of claim 12, wherein the signaled information comprises at least one of: a position of a first bit of the original content of the source picture for the first range and a number of at least one bit allocated to the first range, or a position of a first bit of the original content of the source picture for the second range and a number of at least one bit allocated to the second range.

14. The apparatus of claim 11, wherein:
the first set of at least one bit of the original content of the source picture allocated to the first range of at least one bit comprises a number of most significant bits of the original content of the source picture, and
the second set of at least one bit of the original content of the source picture allocated to the second range of at least one bit comprises a number of less significant bits of the original content of the source picture.

15. The apparatus of claim 11, wherein the first range of at least one bit and the second range of at least one bit are composited within the coded picture using at least one subpicture or at least one constituent rectangle.

16. The apparatus of claim 11, wherein the apparatus is further caused to:
received signaled information comprising an offset that applies to the coded picture, wherein the offset indicates a number of zero or more positions a bit in samples corresponding to the first range or the second range is shifted to a higher order position;
wherein the target picture is reconstructed based on the signaled information.

17. The apparatus of claim 11, wherein the apparatus is further caused to:
receive signaled information comprising an indication of: a beginning of the first range of at least one bit that is coded into the first region, or a beginning of the second range of at least one bit that is coded into the second region;
wherein the target picture is reconstructed based on the signaled information.

18. The apparatus of claim 11, wherein at least one bit of the original content of the source picture is discarded, such that the at least one bit of the original content of the source picture that is discarded is not allocated to the first range of at least one bit or to the second range of at least one bit.

19. An apparatus comprising:
at least one processor; and
at least one memory storing instructions that, when executed by the at least one processor, cause the apparatus at least to:
receive a first coded picture and a second coded picture;
wherein the first coded picture comprises an allocation of a first set of at least one bit of an original content of a source picture to a first range of at least one bit that is coded into the first coded picture;
wherein the second coded picture comprises an allocation of a second set of at least one bit of the original content of the source picture to a second range of at least one bit that is coded into the second coded picture;
receive signaled information related to at least one of: a coding of the first range of at least one bit into the first coded picture, or a coding of the second range of at least one bit into the second coded picture;
wherein the signaled information comprises at least one of: a position of a first bit of the original content of the source picture for the first range and a number of at least one bit allocated to the first range, or a position of a first bit of the original content of the source picture for the second range and a number of at least one bit allocated to the second range; and
reconstruct at least one target picture having a bit depth comprising a bit depth of at least one of the first coded picture or the second coded picture, based on the signaled information.

20. The apparatus of claim 19, wherein the signaled information comprises an offset that applies to the first coded picture or the second coded picture, wherein the offset indicates a number of zero or more positions a bit in samples corresponding to the first range or the second range is shifted to a higher order position.
